(19) United States
(12) Patent Application Publication
(10) Pub. No.: US 2026/0196929 A1
(43) Pub. Date: Jul. 9, 2026

(54) COMMON MODE NOISE MITIGATION SYSTEM

(71) Applicant: AMPERESAND PTE LTD., Singapore (SG)

(72) Inventors: Howe Li YEO, Singapore (SG); Gil Lampong Opina, JR., Singapore (SG); Hlaing Win, Singapore (SG)

(21) Appl. No.: 19/439,795

(22) Filed: Jan. 5, 2026

Related U.S. Application Data
(60) Provisional application No. 63/741,569, filed on Jan. 3, 2025.

(51) Int. Cl. H02M 1/44; H02M 1/08; H02M 3/335

(52) U.S. Cl. CPC H02M 1/44; H02M 1/08; H02M 3/335

(57) ABSTRACT

A converter control system mitigates common mode electromagnetic noise within a converter. The converter control system includes converter circuitry. The converter control system includes converter circuitry including an alternating current (AC)-direct current (DC) power conversion stage and a DC-DC power conversion stage. A noise mitigation system of the converter control system is configured to obtain a common mode noise amount within the converter circuitry, regulate a DC-DC modulation parameter of DC-DC stage switches of the DC-DC power conversion stage based on the common mode noise amount, tune a DC-DC gate driver parameter of DC-DC gate drivers of the DC-DC power conversion stage based on a first updated common mode noise amount, regulate an AC-DC modulation parameter of AC-DC stage switches of the AC-DC power conversion stage, and tune an AC-DC gate driver parameter of AC-DC gate drivers of the AC-DC power conversion stage based on further updated common mode noise amounts.

### CROSS REFERENCE TO RELATED APPLICATIONS

This application claims the benefit under 35 U.S.C. § 119 (e) of U.S. Provisional Patent Application No. 63/741,569, filed Jan. 3, 2025, the disclosure of which is hereby incorporated by reference.

### TECHNICAL FIELD

This disclosure pertains to electronic controlling of converters such as solid state transformers (SSTs).

### BACKGROUND

Power electronics provide a newfound resiliency to the energy infrastructure. For example, power electronics integrate different energy sources, such as renewable energy sources, into the electric grid. However, electromagnetic noise, such as common mode noise, may detrimentally interfere with the operation of power electronics. Common mode noise may arise from frequent switching of switches within the power electronics, ground loops, radio frequency (RF) interference, or unshielded cables. Common mode noise may be manifested as unwanted or unintended interference current induced on both signal and return wires simultaneously and equally in the same direction. Common mode noise may complete its circuit via a return path to a ground or Earth.

### SUMMARY

A converter within an energy distribution system may include different power conversion stages, such as an alternating current (AC)-direct current (DC) power conversion stage (e.g., a front end) and a DC-DC power conversion stage. Electromagnetic noise such as common mode noise may arise in both AC-DC and DC-DC power conversion stages. Common mode noise arising in one stage can propagate to another stage via shared buses and nodes. Common mode noise, which may be measured at a node, is proportional to a time rate of change of voltage with respect to a ground and proportional to parasitic capacitance with respect to the ground. Common mode noise may be manifested as common mode current. For example, common mode current i_{cm} is related to rate of change of voltage v_{cm}, with respect to ground, and parasitic capacitance with respect to ground, c_{cm} through the following equation

$${i}_{c m} = {C}_{c m} \frac{{dv}_{c m}}{dt} .$$

High i_{cm} peaks may be generated every time complementary pairs of semiconductor switches transition ON or OFF due to high dv_{cm}/dt and parasitic capacitance. Common mode noise may be more prevalent in the DC-DC power conversion stage because the DC-DC power conversion stage typically operates at high switching frequencies and exhibits rapid voltage changes over time at switching nodes of the DC-DC power conversion stage.

Common mode noise may cause detrimental consequences within a converter if left unregulated. Common mode noise may cause disruption of converter circuitry operation and performance degradation. Common mode noise may also radiate and amplify unwanted interference such as electromagnetic interference (EMI) to other circuit components. Common mode noise may additionally trigger false signals or errors such as unwanted resets or nuisance tripping of protection circuitry. Common mode noise may also create potentially dangerous float voltages on conductive chassis.

Existing systems that attempt to address common mode noise mitigation may have shortcomings. Such shortcomings may include causing unacceptable power quality decreases due to excessive harmonic distortion, causing excessive power losses, or requiring additional bulky components.

A claimed solution rooted in electronic technology overcomes problems such as the aforementioned common mode noise problems specifically arising in the realm of electronic technology. The claimed solution implements a lightweight converter control system to mitigate common mode noise. A converter control system implements stage-aware noise mitigation according to the DC-DC stage and the AC-DC stage. The converter control system quantifies common mode noise across different loading conditions, and dynamically performs noise mitigation by regulating one or more modulation parameters or tuning one or more gate driver parameters. The converter control system demonstrates a technical benefit due to the ability to mitigation common mode noise while maintaining power quality and efficiency, and without introducing bulky hardware components.

The converter control system may include converter circuitry such as, for example, a solid state transformer (SST). The converter circuitry may be configured to transform and distribute energy from one or more energy storage components to one or more loads that draw energy from the energy storage components. The converter circuitry may include multiple power conversion stages (e.g., two, three, or any number of power conversion stages) such as the AC-DC power conversion stage and the DC-DC power conversion stage. In some embodiments, the DC-DC power conversion stage includes one or more half bridges or dual active bridges (DABs). In some embodiments, the converter circuitry includes one or more noise mitigating devices such as chokes, capacitors, snubbers, or filters. The noise mitigating devices may be coupled to switching nodes, rails, or other locations of the converter circuitry at which common mode noise may be most likely to arise or which common mode noise may be most likely to be reduced. Because of the effectiveness of the converter control system in implementing common mode noise mitigation, the noise mitigating devices may be fewer in number or smaller, which makes the converter circuitry lightweight.

The converter control system may include a common mode noise mitigation system configured to mitigate electromagnetic noise such as common mode noise within the DC-DC power conversion stage, or within both the DC-DC and AC-DC power conversion stages. In some embodiments, the converter control system verifies that a power loss in at least a portion of the converter circuitry is acceptable. Following verification, the converter control system may determine whether a level of common mode noise at one of more locations of the converter circuitry is acceptable. If the level of common mode noise is unacceptable, then the converter control system may implement mitigation of common mode noise. As previously described, the DC-DC power conversion stage may have higher amount of common mode noise compared to the AC-DC power conversion stage. In some embodiments, the converter control system implements mitigation of DC-DC stage common mode noise initially by selectively regulating one or more DC-DC stage switching parameters. The DC-DC stage switching parameters correspond to one or more DC-DC stage switches of the DC-DC power conversion stage.

If the converter control system determines that the common mode noise has been sufficiently mitigated following mitigation of DC-DC stage common mode noise, the converter control system may refrain from implementing mitigation of AC-DC stage common mode noise. If the converter control system determines that the common mode noise is insufficiently mitigated, the converter control system may implement mitigation of AC-DC stage common mode noise. Insufficiently mitigated may be construed as the level of common mode noise still failing to satisfy common mode noise thresholds or common mode noise standards following mitigation of DC-DC stage common mode noise. The sequential implementation of DC-DC stage common mode noise prior to AC-DC stage common mode noise constitutes a technical benefit. The converter control system isolates individual sources of common mode noise between the DC-DC stage and the AC-DC stage. Initially, the converter control system identifies and addresses likely sources of highest common mode noise, which makes the common mode noise mitigation strategy efficient.

Within each power conversion stage, the converter control system may regulate one or more switching parameters according to one or more common mode noise attributes that indicate a level of common mode noise. Switching parameters may include modulation parameters or gate driver parameters. The modulation parameters may include a DC-DC modulation parameter corresponding to one or more DC-DC stage switches of the DC-DC power conversion stage or an AC-DC modulation parameter corresponding to one or more AC-DC stage switches of the AC-DC power conversion stage. For example, the modulation parameters may correspond to a DC-DC stage phase shift corresponding to the one or more DC-DC stage switches, or an AC-DC stage phase shift corresponding to the one or more AC-DC stage switches. Regulating one or more phase shifts may alter the timing between switching cycles of the corresponding switches. For example, increasing one or more phase shifts may increase a dead time and reduce voltage overshoot and ringing, thereby decreasing the time rate at which voltage changes at a switching node. The decreased time rate at which voltage changes may decrease the amount of common mode noise. Meanwhile, the converter control system may ensure that increasing the one or more phase shifts does not unduly increase switching losses or compromise thermal margins, thereby maintaining performance of the converter.

In some embodiments, in each power conversion stage, the converter control system is configured to initially regulate the one or more modulation parameters. If, after regulating the one or more modulation parameters, the common mode noise still fails to satisfy a common mode noise threshold, the converter control system may tune one or more gate driver parameters. If regulating the one or more modulation parameters results in satisfactory common mode noise levels, then the converter control system may refrain from tuning gate driver parameters. The gate driver parameters may include a DC-DC gate driver parameter corresponding to a DC-DC gate driver resistance or an AC-DC gate driver parameter corresponding to a AC-DC gate driver resistance. In some embodiments, a gate driver resistance may refer to a resistance of a resistor in series between a gate driver circuit and the gate terminal of a transistor. Tuning a gate driver resistance may alter a level of responsiveness of the corresponding gate driver that programs ON or OFF states of corresponding switches. For example, increasing a gate driver resistance may slow down a reaction time or increase a duration of time during switching transitions of the corresponding gate driver, which increases a transition time duration of changing a switch from ON to OFF, or from OFF to ON. The increased time duration decreases a time rate at which voltage changes at a switching node, which may decrease the amount of common mode noise. Meanwhile, increasing gate driver resistance does not unduly increase switching losses or compromise thermal margins, thereby maintaining performance of the converter.

The one or more common mode noise attributes may be indicative of an amount of common mode noise. In some embodiments, the one or more common mode noise attributes include a common mode current, a rate of change of voltage with respect to ground, a parasitic capacitance with respect to ground, a parasitic inductance with respect to ground, or a resonance between the parasitic capacitance and the parasitic inductance. In some embodiments, the one or more common mode noise attributes may include one or more isolated amounts of common mode noise measured at one or more isolated locations such as one or more switching nodes, or isolated loops. In some embodiments, the one or more common mode noise attributes may include a cumulative common mode noise amount across different locations or different loops.

In some embodiments, common mode noise mitigation may introduce distortions such as harmonics, ripples, or fluctuations in current or voltage waveforms which degrade a power quality. For example, increasing gate resistance slows switching behaviors which may increase overlap of voltage and current waveforms or distort a current waveform. Current waveform distortion potentially results in generation of lower frequency harmonics. Increasing gate resistance may smooth out voltage or current transitions but may deform a waveform, which may increase lower-order harmonic distortion. As another example, certain noise mitigation devices such as common mode chokes or capacitors may amplify certain harmonics. By adjusting DC-DC stage switching parameters before adjusting AC-DC stage switching parameters, and refraining from adjusting AC-DC stage switching parameters if common mode noise has been sufficiently mitigated, the converter control system already prevents unnecessary decrease of power quality at the AC-DC stage. The converter control system may implement additional precautionary steps to ensure power quality satisfies one or more power quality thresholds corresponding to power quality standards.

The converter control system may ensure, before, during, or after each implementation of common mode noise mitigation (e.g., each change of a switching parameter), satisfaction of a power quality standard of power outputted by the converter circuitry. One example of a power quality standard is Current Total Demand Distortion (iTDD) which divides a total harmonic current by a peak demand of load current. Satisfaction of a power quality standard may be determined at one or more specific locations or portions of the converter circuitry or across the entire converter circuitry.

In some embodiments, the converter control system is configured to determine a power quality standard by sampling or assessing an energy waveform (e.g., a current waveform) at one or more locations such as at one or more AC sides of the converter circuitry. For example, the converter control system may sample or assess a current waveform at an input of a rectifier or an output of an inverter, a grid side corresponding to AC input lines of a rectifier, or a DC link between the AC-DC stage and the DC-DC stage. In some embodiments, the converter control system may obtain one or more signals from a power quality analyzer, oscilloscope, or harmonics meter to determine a power quality.

If the power quality falls outside of one or more power quality standards, the converter control system may terminate operation of the converter circuitry, roll back any common mode noise mitigation, or implement corrective actions to mitigate any distortions. Rolling back common mode noise mitigation may include reversing any changes to switching parameters to previous switching parameters which satisfied the power quality standard.

Examples of corrective actions may include adjusting switching parameters such as changing modulation pattern, reducing switching frequency, or modifying control logic associated with one or more gate drivers. Other corrective actions may include adjusting control logic associated with one or more noise mitigation devices (e.g., filters). If the power quality falls within the one or more power quality standards, then the converter control system may proceed to implement or continue to implement common mode noise mitigation. Therefore, the converter control system balances between considerations of power quality, performance, and mitigation of common mode noise. The converter control system may ensure compliance of standards such as regulatory standards (e.g., based on Institute of Electrical and Electronics Engineers (IEEE) 519).

According to various embodiments of the disclosed technology is a converter control system for mitigating common mode noise within a converter. The converter control system comprises converter circuitry including an alternating current (AC)-direct current (DC) power conversion stage and a DC-DC power conversion stage. The converter control system comprises a common mode noise mitigation system comprising: one or more interfaces configured to communicate with the converter circuitry; and controller circuitry configured to perform operations. The operations include, at different converter loading conditions: obtaining a power loss attribute indicative of power loss in at least a portion of the controller circuitry; and in response to the power loss attribute satisfying a power loss threshold, obtaining a common mode noise attribute indicative of an amount of common mode noise within one or more locations corresponding to the converter circuitry; selectively regulating one or more DC-DC stage switching parameters corresponding to one or more DC-DC stage switches of the DC-DC power conversion stage based on the common mode noise attribute at the different loading conditions; in response to regulating the one or more DC-DC stage switching parameters: at the different loading conditions: obtaining one or more updated common mode noise attributes indicative of one or more updated amounts of the common mode noise at the different loading conditions; and obtaining a power quality attribute indicative of a power quality of power outputted through the controller circuitry; and in response to the power quality attribute satisfying a power quality threshold, selectively regulating one or more AC-DC stage switching parameters corresponding to one or more AC-DC stage switches of the AC-DC power conversion stage based on an updated common mode noise attribute.

In some embodiments, the DC-DC stage switching parameters comprise a DC-DC modulation parameter or a DC-DC gate driver parameter; and selectively regulating the one or more DC-DC stage switching parameters comprises: selectively regulating the DC-DC modulation parameter based on the common mode noise attribute; in response to regulating the DC-DC modulation parameter, obtaining a first updated common mode noise attribute indicative of a first updated amount of the common mode noise; selectively tuning the DC-DC gate driver parameter corresponding to one or more DC-DC gate drivers of the DC-DC power conversion stage based on the first updated amount of the common mode noise; in response to tuning the DC-DC gate driver parameter, obtaining a second updated common mode noise attribute indicative of a second updated amount of the common mode noise; and selectively regulating the one or more AC-DC stage switching parameters comprises: selectively regulating an AC-DC modulation parameter corresponding to one or more AC-DC stage switches of the AC-DC power conversion stage based on the second updated common mode noise attribute; in response to regulating the AC-DC modulation parameter, obtaining a third updated common mode noise attribute indicative of a third updated amount of the common mode noise; and selectively tuning an AC-DC gate driver parameter corresponding to one or more AC-DC gate drivers of the AC-DC power conversion stage based on the third updated amount of the common mode noise, and wherein: the one or more locations correspond to one or more switching nodes of the converter circuitry, the one or more DC-DC stage switches correspond to one or more half bridges or dual active bridges (DABs).

In some embodiments, the DC-DC modulation parameter comprises a DC-DC stage phase shift corresponding to the one or more DC-DC stage switches, and selectively regulating the DC-DC modulation parameter comprises: in response to the amount of the common mode noise being above a threshold common mode noise level, increasing the DC-DC stage phase shift corresponding to the one or more DC-DC stage switches if an increase in the DC-DC stage phase shift lowers the amount of the common mode noise.

In some embodiments, the DC-DC gate driver parameter comprises a DC-DC gate driver resistance; and selectively tuning the DC-DC gate driver parameter comprises: in response to the first updated amount of the common mode noise being above a threshold common mode noise level, increasing the DC-DC gate driver resistance if the DC-DC gate driver resistance is increasable and if an increase in the DC-DC gate driver resistance lowers the amount of the common mode noise.

In some embodiments, the AC-DC modulation parameter comprises an AC-DC stage phase shift corresponding to the one or more AC-DC stage switches, and selectively regulating the AC-DC modulation parameter comprises: in response to the second updated amount of the common mode noise being above a threshold common mode noise level, increasing the AC-DC stage phase shift corresponding to the one or more AC-DC stage switches if an increase in the AC-DC stage phase shift lowers the amount of the common mode noise.

In some embodiments, the AC-DC gate driver parameter comprises an AC-DC gate driver resistance; and selectively tuning the AC-DC gate driver parameter comprises: in response to the third updated amount of the common mode noise being above a threshold common mode noise level, increasing the AC-DC gate driver resistance if the AC-DC gate driver resistance is increasable (e.g., given hardware or other feasibility constraints).

In some embodiments, the DC-DC modulation parameter comprises a DC-DC stage phase shift corresponding to the one or more DC-DC stage switches, and selectively regulating the DC-DC modulation parameter comprises: in response to the amount of the common mode noise being above a threshold common mode noise level, iteratively increasing the DC-DC stage phase shift corresponding to the one or more DC-DC stage switches if an increase in the DC-DC stage phase shift lowers the amount of the common mode noise; and at each DC-DC stage phase shift increase iteration, obtaining a first iteratively updated common mode noise attribute indicative of a first iteratively updated amount of the common mode noise, wherein the iteratively increasing the DC-DC stage phase shift comprises iteratively increasing the DC-DC stage phase shift until the first iteratively updated amount of the common mode noise falls within the threshold common mode noise level, wherein the first iteratively updated common mode noise attribute corresponds to the first updated common mode noise attribute; and selectively tuning the DC-DC gate driver parameter comprises: in response to the DC-DC stage phase shift reaching a DC-DC stage phase shift threshold, and the first iteratively updated amount of the common mode noise still being above the threshold common mode noise level, tuning the DC-DC gate driver parameter, wherein at the DC-DC stage phase shift threshold, any permissible change in the DC-DC stage phase shift fails to lower the amount of the common mode noise.

In some embodiments, the DC-DC gate driver parameter comprises a DC-DC gate driver resistance; and selectively tuning the DC-DC gate driver parameter comprises: in response to the first updated amount of the common mode noise being above a threshold common mode noise level, iteratively increasing the DC-DC gate driver resistance if the DC-DC gate driver resistance is increasable and if an increase in the DC-DC gate driver resistance lowers the amount of the common mode noise; and at each DC-DC gate driver resistance increase iteration, obtaining a second iteratively updated common mode noise attribute indicative of a second iteratively updated amount of the common mode noise, wherein the iteratively increasing the DC-DC gate driver resistance comprises iteratively increasing the DC-DC gate driver resistance until the second iteratively updated amount of the common mode noise falls within the threshold common mode noise level, wherein the second iteratively updated common mode noise attribute corresponds to the second updated common mode noise attribute; and selectively tuning the AC-DC gate driver parameter comprises: in response to the DC-DC gate driver resistance reaching a DC-DC gate driver resistance threshold, and the second iteratively updated amount of the common mode noise still being above the threshold common mode noise level, regulating the AC-DC modulation parameter, wherein at the DC-DC gate driver resistance threshold, any permissible change in the DC-DC gate driver resistance fails to lower the amount of the common mode noise.

In some embodiments, selectively regulating the AC-DC modulation parameter comprises: iteratively increasing the AC-DC stage phase shift corresponding to the one or more AC-DC stage switches if an increase in the AC-DC stage phase shift lowers the amount of the common mode noise; and at each AC-DC stage phase shift increase iteration, obtaining a third iteratively updated common mode noise attribute indicative of a third iteratively updated amount of the common mode noise, wherein the iteratively increasing the AC-DC stage phase shift comprises iteratively increasing the AC-DC stage phase shift until the third iteratively updated amount of the common mode noise falls within the threshold common mode noise level, wherein the third iteratively updated common mode noise attribute corresponds to the third updated common mode noise attribute; and selectively tuning the AC-DC gate driver parameter comprises: in response to the AC-DC stage phase shift reaching a AC-DC stage phase shift threshold, and the third iteratively updated amount of the common mode noise still being above the threshold common mode noise level, tuning the AC-DC gate driver parameter, wherein at the AC-DC stage phase shift threshold, any permissible change in the AC-DC stage phase shift fails to lower the amount of the common mode noise.

In some embodiments, the controller circuitry is further configured to perform: in response to determining that the DC-DC gate driver resistance has reached a DC-DC gate driver resistance threshold, and the second iteratively updated amount of the common mode noise still being above the threshold common mode noise level, determining whether a power quality is within a power quality threshold, wherein at the DC-DC gate driver resistance threshold, any permissible change in the DC-DC gate driver resistance fails to lower the amount of the common mode noise; and selectively regulating the AC-DC modulation parameter is in response to determining that the power quality is within a power quality threshold.

According to various embodiments of the disclosed technology is a method for mitigating common mode electromagnetic noise within a converter implemented by controller circuitry within a common mode noise mitigation system of a converter control system, the electric system comprising converter circuitry including an alternating current (AC)-direct current (DC) power conversion stage and a DC-DC power conversion stage, the converter control system comprising the controller circuitry and one or more interfaces communicating with the converter circuitry, the method comprising: at different converter loading conditions: obtaining a power loss attribute indicative of power loss in at least a portion of the controller circuitry; and in response to the power loss attribute satisfying a power loss threshold, obtaining a common mode noise attribute indicative of an amount of common mode noise within one or more locations corresponding to the converter circuitry; selectively regulating one or more DC-DC stage switching parameters corresponding to one or more DC-DC stage switches of the DC-DC power conversion stage based on the common mode noise attribute at the different loading conditions; in response to regulating the one or more DC-DC stage switching parameters: at the different loading conditions: obtaining one or more updated common mode noise attributes indicative of one or more updated amounts of the common mode noise at the different loading conditions; and obtaining a power quality attribute indicative of a power quality of power outputted through the controller circuitry; and in response to the power quality attribute satisfying a power quality threshold, selectively regulating one or more AC-DC stage switching parameters corresponding to one or more AC-DC stage switches of the AC-DC power conversion stage based on an updated common mode noise attribute.

### BRIEF DESCRIPTION OF THE DRAWINGS

FIG. 1 is a diagram of an example energy distribution system including an energy source and a converter control system, according to some embodiments.

FIG. 2 is a diagram of an example converter control system including converter circuitry and a common mode noise mitigation system, according to some embodiments.

FIG. 3 is a diagram of an example converter control system, according to some embodiments.

FIG. 4 is a diagram of an example medium voltage rectifier leg, according to some embodiments.

FIG. 5 is a diagram of an example direct current (DC)-DC stage control system, according to some embodiments.

FIG. 6 is a diagram of an example converter control system testing setup, according to some embodiments.

FIG. 7 is a flowchart of a DC-DC stage noise mitigation method, according to some embodiments.

FIG. 8 is a flowchart of an alternating current (AC)-DC stage modulation adjustment method, according to some embodiments.

FIG. 9 is a flowchart of an AC-DC stage gate drive tuning method, according to some embodiments.

FIG. 10 is a block diagram of a computer system upon which any of the embodiments described herein may be implemented.

### DETAILED DESCRIPTION

A converter within an energy distribution system may include different power conversion stages, such as an alternating current (AC)-direct current (DC) power conversion stage (e.g., a front end) and a DC-DC power conversion stage. Electromagnetic noise such as common mode noise may arise in both AC-DC and DC-DC power conversion stages. Common mode noise arising in one stage can propagate to another stage via shared buses and nodes. Common mode noise, which may be measured at a node, is proportional to a time rate of change of voltage with respect to a ground and proportional to parasitic capacitance with respect to the ground. Common mode noise may be manifested as common mode current. For example, common mode current i_{cm} is related to rate of change of voltage v_{cm}, with respect to ground, and parasitic capacitance with respect to ground, C_{cm} through the following equation

$${i}_{c m} = {C}_{c m} \frac{{dv}_{c m}}{dt} .$$

High i_{cm} peaks may be generated every time complementary pairs of semiconductor switches transition ON or OFF due to high dv_{cm}/dt and parasitic capacitance. Common mode noise may be more prevalent in the DC-DC power conversion stage because the DC-DC power conversion stage typically operates at high switching frequencies and exhibits rapid voltage changes over time at switching nodes of the DC-DC power conversion stage.

Common mode noise may cause detrimental consequences within a converter if left unregulated. Common mode noise may cause disruption of converter circuitry operation and performance degradation. Common mode noise may also radiate and amplify unwanted interference such as electromagnetic interference (EMI) to other circuit components. Common mode noise may additionally trigger false signals or errors such as unwanted resets or nuisance tripping of protection circuitry. Common mode noise may also create potentially dangerous float voltages on conductive chassis.

Existing systems that attempt to address common mode noise mitigation may have shortcomings. Such shortcomings may include causing unacceptable power quality decreases due to excessive harmonic distortion, causing excessive power losses, or requiring additional bulky components.

A claimed solution rooted in electronic technology overcomes problems such as the aforementioned common mode noise problems specifically arising in the realm of electronic technology. The claimed solution implements a lightweight converter control system to mitigate common mode noise. A converter control system implements stage-aware noise mitigation according to the DC-DC stage and the AC-DC stage. The converter control system quantifies common mode noise across different loading conditions, and dynamically performs noise mitigation by regulating one or more modulation parameters or tuning one or more gate driver parameters. The converter control system demonstrates a technical benefit due to the ability to mitigation common mode noise while maintaining power quality and efficiency, and without introducing bulky hardware components.

The converter control system may include converter circuitry such as, for example, a solid state transformer (SST). The converter circuitry may be configured to transform and distribute energy from one or more energy storage components to one or more loads that draw energy from the energy storage components. The converter circuitry may include multiple power conversion stages (e.g., two, three, or any number of power conversion stages) such as the AC-DC power conversion stage and the DC-DC power conversion stage. In some embodiments, the DC-DC power conversion stage includes one or more half bridges or dual active bridges (DABs). In some embodiments, the converter circuitry includes one or more noise mitigating devices such as chokes, capacitors, snubbers, or filters. The noise mitigating devices may be coupled to switching nodes, rails, or other locations of the converter circuitry at which common mode noise may be most likely to arise or which common mode noise may be most likely to be reduced. Because of the effectiveness of the converter control system in implementing common mode noise mitigation, the noise mitigating devices may be fewer in number or smaller, which makes the converter circuitry lightweight.

The converter control system may include a common mode noise mitigation system configured to mitigate electromagnetic noise such as common mode noise within the DC-DC power conversion stage, or within both the DC-DC and AC-DC power conversion stages. In some embodiments, the converter control system verifies that a power loss in at least a portion of the converter circuitry is acceptable. Following verification, the converter control system may determine whether a level of common mode noise at one of more locations of the converter circuitry is acceptable. If the level of common mode noise is unacceptable, then the converter control system may implement mitigation of common mode noise. As previously described, the DC-DC power conversion stage may have higher amount of common mode noise compared to the AC-DC power conversion stage. In some embodiments, the converter control system implements mitigation of DC-DC stage common mode noise initially by selectively regulating one or more DC-DC stage switching parameters. The DC-DC stage switching parameters correspond to one or more DC-DC stage switches of the DC-DC power conversion stage.

If the converter control system determines that the common mode noise has been sufficiently mitigated following mitigation of DC-DC stage common mode noise, the converter control system may refrain from implementing mitigation of AC-DC stage common mode noise. If the converter control system determines that the common mode noise is insufficiently mitigated, the converter control system may implement mitigation of AC-DC stage common mode noise. Insufficiently mitigated may be construed as the level of common mode noise still failing to satisfy common mode noise thresholds or common mode noise standards following mitigation of DC-DC stage common mode noise. The sequential implementation of DC-DC stage common mode noise prior to AC-DC stage common mode noise constitutes a technical benefit. The converter control system isolates individual sources of common mode noise between the DC-DC stage and the AC-DC stage. Initially, the converter control system identifies and addresses likely sources of highest common mode noise, which makes the common mode noise mitigation strategy efficient.

Within each power conversion stage, the converter control system may regulate one or more switching parameters according to one or more common mode noise attributes that indicate a level of common mode noise. Switching parameters may include modulation parameters or gate driver parameters. The modulation parameters may include a DC-DC modulation parameter corresponding to one or more DC-DC stage switches of the DC-DC power conversion stage or an AC-DC modulation parameter corresponding to one or more AC-DC stage switches of the AC-DC power conversion stage. For example, the modulation parameters may correspond to a DC-DC stage phase shift corresponding to the one or more DC-DC stage switches, or an AC-DC stage phase shift corresponding to the one or more AC-DC stage switches. Regulating one or more phase shifts may alter the timing between switching cycles of the corresponding switches. For example, increasing one or more phase shifts may increase a dead time and reduce voltage overshoot and ringing, thereby decreasing the time rate at which voltage changes at a switching node. The decreased time rate at which voltage changes may decrease the amount of common mode noise. Meanwhile, the converter control system may ensure that increasing the one or more phase shifts does not unduly increase switching losses or compromise thermal margins, thereby maintaining performance of the converter.

In some embodiments, in each power conversion stage, the converter control system is configured to initially regulate the one or more modulation parameters. If, after regulating the one or more modulation parameters, the common mode noise still fails to satisfy a common mode noise threshold, the converter control system may tune one or more gate driver parameters. If regulating the one or more modulation parameters results in satisfactory common mode noise levels, then the converter control system may refrain from tuning gate driver parameters. The gate driver parameters may include a DC-DC gate driver parameter corresponding to a DC-DC gate driver resistance or an AC-DC gate driver parameter corresponding to a AC-DC gate driver resistance. In some embodiments, a gate driver resistance may refer to a resistance of a resistor in series between a gate driver circuit and the gate terminal of a transistor. Tuning a gate driver resistance may alter a level of responsiveness of the corresponding gate driver that programs ON or OFF states of corresponding switches. For example, increasing a gate driver resistance may slow down a reaction time or increase a duration of time during switching transitions of the corresponding gate driver, which increases a transition time duration of changing a switch from ON to OFF, or from OFF to ON. The increased time duration decreases a time rate at which voltage changes at a switching node, which may decrease the amount of common mode noise. Meanwhile, increasing gate driver resistance does not unduly increase switching losses or compromise thermal margins, thereby maintaining performance of the converter.

The one or more common mode noise attributes may be indicative of an amount of common mode noise. In some embodiments, the one or more common mode noise attributes include a common mode current, a rate of change of voltage with respect to ground, a parasitic capacitance with respect to ground, a parasitic inductance with respect to ground, or a resonance between the parasitic capacitance and the parasitic inductance. In some embodiments, the one or more common mode noise attributes may include one or more isolated amounts of common mode noise measured at one or more isolated locations such as one or more switching nodes, or isolated loops. In some embodiments, the one or more common mode noise attributes may include a cumulative common mode noise amount across different locations or different loops.

In some embodiments, common mode noise mitigation may introduce distortions such as harmonics, ripples, or fluctuations in current or voltage waveforms which degrade a power quality. For example, increasing gate resistance slows switching behaviors which may increase overlap of voltage and current waveforms or distort a current waveform. Current waveform distortion potentially results in generation of lower frequency harmonics. Increasing gate resistance may smooth out voltage or current transitions but may deform a waveform, which may increase lower-order harmonic distortion. As another example, certain noise mitigation devices such as common mode chokes or capacitors may amplify certain harmonics. By adjusting DC-DC stage switching parameters before adjusting AC-DC stage switching parameters, and refraining from adjusting AC-DC stage switching parameters if common mode noise has been sufficiently mitigated, the converter control system already prevents unnecessary decrease of power quality at the AC-DC stage. The converter control system may implement additional precautionary steps to ensure power quality satisfies one or more power quality thresholds corresponding to power quality standards.

The converter control system may ensure, before, during, or after each implementation of common mode noise mitigation (e.g., each change of a switching parameter), satisfaction of a power quality standard of power outputted by the converter circuitry. One example of a power quality standard is Current Total Demand Distortion (iTDD) which divides a total harmonic current by a peak demand of load current. Satisfaction of a power quality standard may be determined at one or more specific locations or portions of the converter circuitry or across the entire converter circuitry.

In some embodiments, the converter control system is configured to determine a power quality standard by sampling or assessing an energy waveform (e.g., a current waveform) at one or more locations such as at one or more AC sides of the converter circuitry. For example, the converter control system may sample or assess a current waveform at an input of a rectifier or an output of an inverter, a grid side corresponding to AC input lines of a rectifier, or a DC link between the AC-DC stage and the DC-DC stage. In some embodiments, the converter control system may obtain one or more signals from a power quality analyzer, oscilloscope, or harmonics meter to determine a power quality.

If the power quality falls outside of one or more power quality standards, the converter control system may terminate operation of the converter circuitry, roll back any common mode noise mitigation, or implement corrective actions to mitigate any distortions. Rolling back common mode noise mitigation may include reversing any changes to switching parameters to previous switching parameters which satisfied the power quality standard.

Examples of corrective actions may include adjusting switching parameters such as changing modulation pattern, reducing switching frequency, or modifying control logic associated with one or more gate drivers. Other corrective actions may include adjusting control logic associated with one or more noise mitigation devices (e.g., filters). If the power quality falls within the one or more power quality standards, then the converter control system may proceed to implement or continue to implement common mode noise mitigation. Therefore, the converter control system balances between considerations of power quality, performance, and mitigation of common mode noise. The converter control system may ensure compliance of standards such as regulatory standards (e.g., based on Institute of Electrical and Electronics Engineers (IEEE) 519).

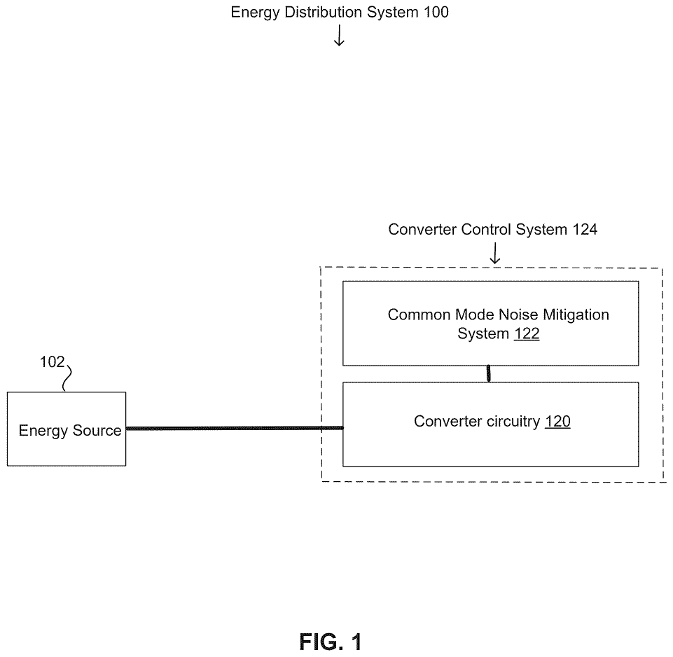

FIG. 1 is a diagram of an example energy distribution system 100. The energy distribution system 100 may include an energy source 102 that supplies input power to the converter circuitry 120. The energy source 102 may include an electric grid, one or more batteries, supercapacitors, renewable energy sources such as photovoltaics, chargers, generators, motors, substations, or other energy sources. The converter circuitry 120 may include a solid state transformer (SST) or one or more converter components thereof. The converter circuitry 120 may include a rectifier (e.g., a half bridge rectifier or a full bridge rectifier) or a dual active bridge (DAB). The converter circuitry 120 may deliver output power to a load. The converter circuitry 120 may be part of a converter control system 124.

The converter control system 124 may include a common mode noise mitigation system 122 configured to mitigate electromagnetic noise such as common mode noise within the converter circuitry 120. In some embodiments, the converter control system verifies that a power loss in at least a portion of the converter circuitry is acceptable. Following verification, the converter control system may determine whether a level of common mode noise at one of more locations of the converter circuitry is acceptable. If the level of common mode noise is unacceptable, then the converter control system may implement mitigation of common mode noise. In some embodiments, the common mode noise mitigation system 122 is configured to selectively regulate one or more switching attributes of the converter circuitry 120 based on one or more attributes. The attributes may include, without limitation, common mode noise attributes indicative of an amount of common mode noise within one or more locations corresponding to the converter circuitry 120. The common mode noise attributes may include or be obtained or derived from any electrical or thermal characteristics within the converter circuitry 120. The electrical characteristics may include one or more total, intended, or parasitic currents, voltages, capacitances, or inductances. For example, the electrical characteristics may include a common mode current, a rate of change of voltage with respect to ground, a parasitic capacitance with respect to ground, a parasitic inductance with respect to ground, or a resonance between the parasitic capacitance and the parasitic inductance.

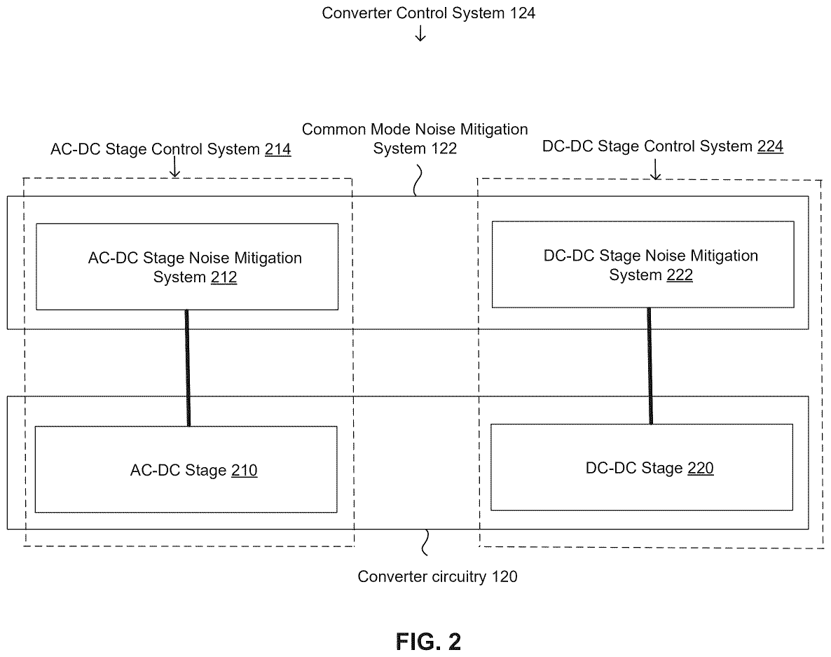

If the level of common mode noise is unacceptable, then the common mode noise mitigation system 122 may implement mitigation of common mode noise. Implementing mitigation of common mode noise may include regulating one or more switching parameters of one or more switches within the converter circuitry 120. Switching parameters may include modulation control parameters or one or more gate driver parameters. In some embodiments, as shown more clearly in FIG. 2, the common mode noise mitigation system 122 may implement mitigation of common mode noise by regulating a DC-DC stage switching parameter within a DC-DC power conversion stage. In some embodiments, if the level of common mode noise is still unacceptable, then the common mode noise mitigation system 122 may regulate an AC-DC stage switching parameter within an AC-DC power conversion stage. Because the DC-DC power conversion stage is more likely to be a source of common mode noise, the common mode noise mitigation system 122 may implement mitigation in an efficient manner.

The switching parameters may include a modulation parameter or a modulation control parameter such as duty cycle of one or more legs (e.g., a primary bridge or a secondary bridge), a phase shift between the primary bridge and the secondary bridge, a phase shift between complementary pairs of switches on the primary bridge, or a phase shift between complementary pairs of switches on the secondary bridge. The modulation parameters may include one or more modulation control modes which correspond to phase shift techniques, such as single phase shift (SPS), double phase shift (DPS), triple phase shift (TPS), or extended phase shift (EPS).

For example, the common mode noise mitigation system 122 may be configured to regulate one or more phase shifts which may alter the timing between switching cycles of the corresponding switches within the converter circuitry 120. For example, increasing one or more phase shifts may increase a dead time and reduce voltage overshoot and ringing, thereby decreasing the time rate at which voltage changes at a switching node. The decreased time rate at which voltage changes may decrease the amount of common mode noise.

In some embodiments, the switching parameters include one or more gate driver parameters corresponding to one or more gate drivers (e.g., drivers) that actuate the switching. In some embodiments, at least one of the gate drivers may be programmable or digitally controlled. The common mode noise mitigation system 122 may be configured to selectively tune a gate driver resistance or a gate driver slew rate (e.g., rate of change of voltage at the gate terminal of a transistor during switching). In some embodiments, a gate driver resistance refers to a resistance of a resistor in series between the gate driver circuit and the gate terminal of the transistor. Tuning a gate driver resistance may alter a level of responsiveness of the corresponding gate driver that programs ON or OFF states of corresponding switches. For example, increasing a gate driver resistance may slow down a reaction time of the corresponding gate driver, which increases a transition time duration of changing a switch from ON to OFF, or from OFF to ON. The increased time duration decreases a time rate at which voltage changes at a switching node, which may decrease the amount of common mode noise. Tuning a gate driver resistance or a gate driver slew rate may be performed, for example, via configuration pins, digital inputs, or software commands.

In some embodiments, in each power conversion stage, the common mode noise mitigation system 122 is configured to regulate the one or more modulation control attributes, if the common mode noise attributes initially fail to satisfy a common mode noise standard. If, after regulating the one or more modulation parameters, the common mode noise still fails to satisfy a common mode noise standard, the common mode noise mitigation system 122 is configured to subsequently tune one or more gate driver parameters.

In some embodiments, common mode noise mitigation may introduce distortions such as harmonics, ripples, or fluctuations in current or voltage waveforms which degrade a power quality. For example, increasing gate resistance slows switching behaviors which may increase overlap of voltage and current waveforms or distort a current waveform. Current waveform distortion potentially results in generation of lower frequency harmonics. Increasing gate resistance may smooth out voltage or current transitions but may deform a waveform, which may increase lower-order harmonic distortion. As another example, certain noise mitigation devices such as common mode chokes or capacitors may amplify certain harmonics.

Before, during, or after each instance of regulating or tuning a switching parameter, the common mode noise mitigation system 122 may ensure satisfaction of a power quality standard of power outputted by the converter circuitry. One example of a power quality standard is Current Total Demand Distortion (iTDD) which divides a total harmonic current by a peak demand of load current. Satisfaction of a power quality standard may be determined at one or more specific locations or portions of the converter circuitry 120 or across the entire converter circuitry 120.

In some embodiments, the common mode noise mitigation system 122 is configured to determine a power quality standard by sampling or assessing an energy waveform (e.g., a current waveform) at one or more locations such as at one or more AC sides of the converter circuitry 120. For example, the common mode noise mitigation system 122 may sample or assess a current waveform at an input of a rectifier or an output of an inverter, a grid side corresponding to AC input lines of a rectifier, or a DC link between the AC-DC stage and the DC-DC stage. In some embodiments, the common mode noise mitigation system 122 may obtain one or more signals from a power quality analyzer, oscilloscope, or harmonics meter to determine a power quality.

If the power quality falls outside of one or more power quality standards, the common mode noise mitigation system 122 or the converter control system 124 may terminate operation of the converter circuitry 120 or of the common mode noise mitigation system 122. Additionally or alternatively, the common mode noise mitigation system 122 may roll back any common mode noise mitigation, or implement corrective actions to mitigate any distortions. Rolling back common mode noise mitigation may include reversing any changes to switching parameters to previous switching parameters which satisfied the power quality standard. For example, if increasing phase shift or increasing gate resistance resulted in failure to satisfy one or more power quality standards, then the common mode noise mitigation system 122 may decrease the phase shift or decrease gate resistance to a previous phase shift or a previous gate resistance which satisfied the power quality standards.

Examples of corrective actions may include changing modulation patterns to reshape harmonic energy within input or output currents of the converter circuitry 120. Changing modulation patterns may include changing pulse width modulation (PWM) characteristics such as PWM frequency. For example, increasing PWM frequency may push dominant sidebands to higher orders. PWM frequency of higher orders may be easier for low pass filters or other power line components to attenuate. Another example of a change in modulation pattern may include interleaving, in which multiple legs or phases sharing an input or output are switched with intentional phase shifts such as 360 degrees/N for N phases. By staggering PWM edges of each leg, the individual ripple current or voltages may partially cancel one another out at a shared node. Another example change in modulation pattern may include modifying vector selection or vector sequencing strategies. Vectors may refer to representations of different switching states within a multi-level, multi-phase converter. Certain symmetric sequences may cancel out even harmonics and reduce lower-order distortions. Examples of vector selection or vector sequencing strategies include space-vector PWM or discontinuous PWM strategies to eliminate certain low-order harmonics (e.g., third-order harmonics) by utilizing zero vectors. Zero vectors may represent switching states in which all phase outputs (e.g., three phase outputs) correspond to a same DC rail and produce zero line-to-line voltage.

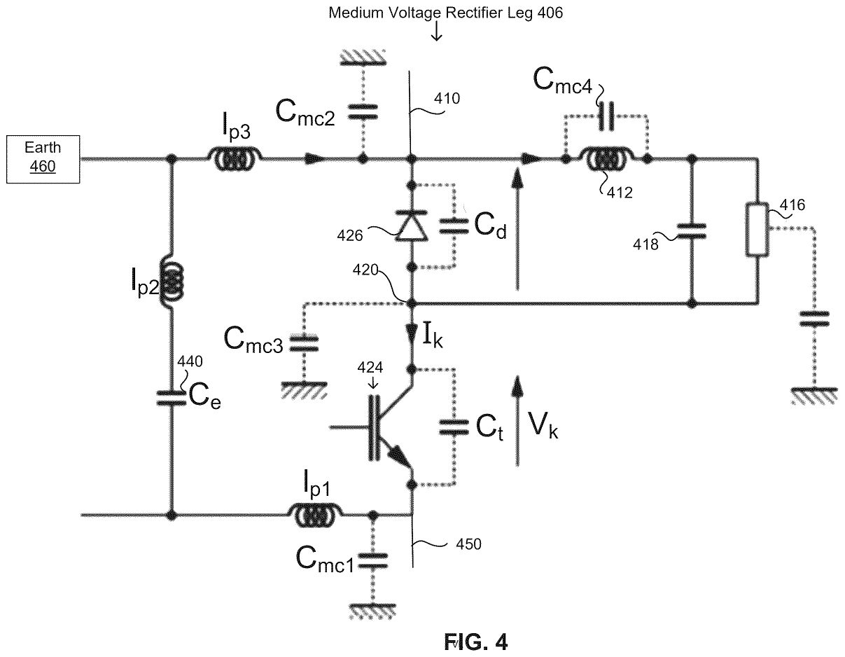

Other examples of corrective actions include modifying control logic associated with one or more gate drivers or with one or more noise mitigation devices. Other examples of corrective actions include load balancing such as redistributing or phase-balancing one or more loads (e.g., load 416 shown in FIG. 4) or mitigating ground loops. Other corrective actions include modifying one or more algorithms (e.g., firmware or software algorithms) to adjust response characteristics of the control circuitry 120, harmonic compensation characteristics, or fault tolerance characteristics. Other corrective actions may include isolating largest contributors of distortions within the control circuitry 120.

If the power quality falls within the one or more power quality standards, then the common mode noise mitigation system 122 may proceed to implement or continue to implement common mode noise mitigation. Therefore, the common mode noise mitigation system 122 balances between considerations of power quality, performance, and mitigation of common mode noise. The converter control system may ensure compliance of standards such as regulatory standards (e.g., based on Institute of Electrical and Electronics Engineers (IEEE) 519).

The common mode noise mitigation system 122 may include software, hardware, or firmware to control the converter circuitry 120. In some embodiments, the common mode noise mitigation system 122 may include one or more processors that read and/or write instructions (e.g., which may include parameters, expressions, protocols, evaluations, conditions, arguments, and/or functions) to implement the control of the operations. These operations may include receiving communications from the converter circuitry 120, or from one or more sensors, and transmitting communications to the converter circuitry 120, via one or more interfaces. The communications may be transmitted over a network. In some embodiments, the common mode noise mitigation system 122 may be configured to generate signals that cause circuitry to be programmed in a specific manner, such as generating signals to one or more drivers to cause certain changes in switching parameters. The one or more drivers may convert the signals into tangible actions such as changes in one or more switching behaviors (e.g., phase shift or gate driver resistance).

In some embodiments, the converter control system 124 may include any subset of the components shown in FIG. 1. For example, the converter control system 124 may include the common mode noise mitigation system 122.

FIG. 2 is a diagram of an example converter control system 124, according to some embodiments. As indicated in FIG. 1, the converter control system 124 includes the converter circuitry 120 and the common mode noise mitigation system 122. The converter circuitry 120 may be partitioned into an alternating current (AC)-direct current (DC) stage 210 (e.g., an AC-DC power conversion stage), and a DC-DC stage 220 (e.g., a DC-DC power conversion stage). In some embodiments, the common mode noise mitigation system 122 is partitioned into an AC-DC stage noise mitigation system 212 configured to mitigate AC-DC stage common mode noise within the AC-DC stage 210 and a DC-DC stage noise mitigation system 222 configured to mitigate DC-DC stage common mode noise within the DC-DC stage. In some embodiments, an AC-DC stage control system 214 includes the AC-DC stage noise mitigation system 212 and the AC-DC stage 210. In some embodiments, a DC-DC stage control system 224 includes the DC-DC stage noise mitigation system 222 and the DC-DC stage 220. In some embodiments, any relevant principles explained for the converter control system 124 or the common mode noise mitigation system 122 may be applicable to the AC-DC stage noise mitigation system 212 or the DC-DC stage noise mitigation system 222.

In some embodiments, because the DC-DC stage 220 may have higher amount of common mode noise, the DC-DC stage noise mitigation system 222 implements mitigation of DC-DC stage common mode noise initially, without the AC-DC stage noise mitigation system 212 implementing mitigation of AC-DC stage common mode noise. Implementing mitigation of DC-DC stage common mode noise may include regulating one or more DC-DC stage switching parameters in the DC-DC stage 220. The DC-DC stage switching parameters may include modulation parameters or gate driver parameters. In some embodiments, the DC-DC stage noise mitigation system 222 regulates a modulation parameter such as a phase shift. If regulation of the modulation parameter causes the common mode noise to decrease to satisfactory levels, then the DC-DC stage noise mitigation system 222 may terminate further mitigation. If the common mode noise levels still are unsatisfactory, then the DC-DC stage noise mitigation system 222 may tune a gate driver parameter such as a gate driver resistance.

If the DC-DC stage noise mitigation system 222 determines that the common mode noise has been sufficiently mitigated, the AC-DC stage noise mitigation system 212 may refrain from implementing mitigation of AC-DC stage common mode noise.

Assume, for the sake of illustration, that the DC-DC stage noise mitigation system 222 determines that the common mode noise still fails to satisfy common mode noise thresholds following mitigation of DC-DC stage common mode noise. Then, the AC-DC stage noise mitigation system 212 may implement mitigation of AC-DC stage common mode noise. Mitigation of AC-DC stage common mode noise may be implemented according to similar principles as in the DC-DC stage 220. For example, the AC-DC stage noise mitigation system 212 may regulate a modulation parameter before tuning a gate driver parameter. The sequential implementation of DC-DC stage common mode noise prior to AC-DC stage common mode noise constitutes a technical benefit. Initially, the converter control system identifies and addresses likely sources of highest common mode noise, which makes the common mode noise mitigation strategy efficient. As a result, once common mode noise has been decreased to a satisfactory standard, then the common mode noise mitigation system 122 conserves resources by refraining from implementing further common noise mitigation measures.

In some embodiments, common mode noise may be measured as cumulative common mode noise across the converter circuitry 120, or localized common mode noise across a portion of the control circuitry (e.g., at one or more switching nodes). Satisfaction of common mode noise levels may be construed as satisfaction of an overall common mode noise level or satisfaction of a localized common mode noise level.

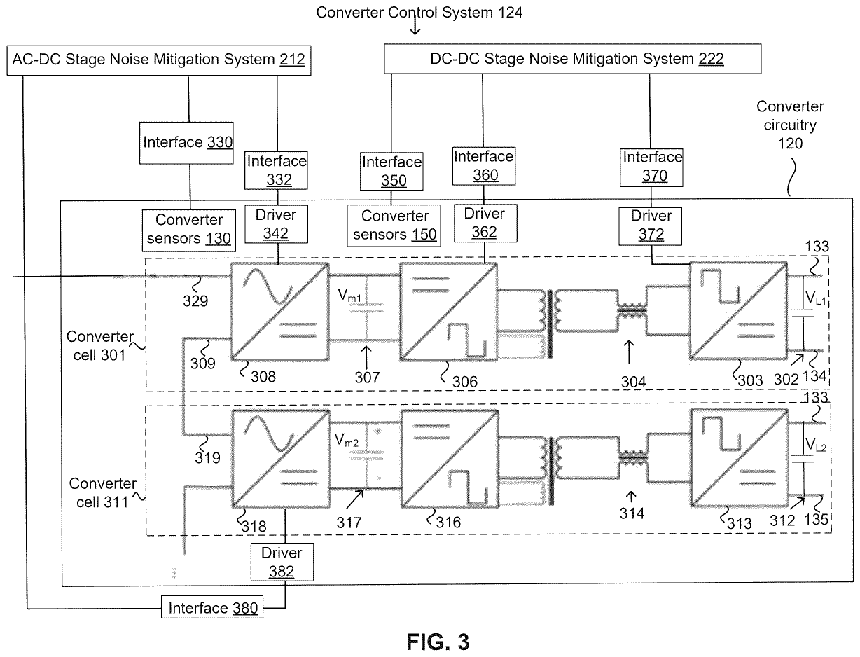

FIG. 3 is a diagram of an example converter control system 124, according to some embodiments. As previously indicated, the converter control system 124 includes the converter circuitry 120, and the common mode noise mitigation system 122. The common mode noise mitigation system 122 includes the AC-DC stage noise mitigation system 212 and the DC-DC stage noise mitigation system 222. In some embodiments, the converter circuitry 120 includes converter cells 301, 311 which may be connected in series across their respective medium voltage links or terminals 309, 319. In some embodiments, each converter cell may handle only a fraction of the total voltage from the energy source 102. In a scenario with two converter cells, each converter cell may handle only a half of the total voltage. In a scenario with n converter cells, each converter cell may handle only 1/n of the total voltage. Although two converter cells 301, 311 are shown in FIG. 3, the converter circuitry 120 may include any number of converter cells, including a scenario with only one converter cell.

The converter cell 301 may include, as part of the DC-DC stage 220, a low voltage bus capacitor 302, which may have a voltage of V_{L1}. In some embodiments, the low voltage bus capacitor 302 may be part of, or be coupled to, the low voltage side of the converter circuitry 120. The low voltage bus capacitor 302 may be connected to a low voltage inverter 303 which converts low voltage DC energy to high-frequency AC energy. The low voltage inverter 303 may be connected to a transformer 304, such as a high frequency isolation transformer to step up AC voltage. The transformer 304 may include a magnetic core and transformer windings. In some embodiments, one or more noise mitigating devices such as a passive choke may be connected to the transformer 304. The transformer 304 may be connected to a medium voltage rectifier 306, which converts high frequency AC energy to DC energy. In some embodiments, the low voltage side of the converter circuitry 120 (e.g., the low voltage side of the converter cell 301), the transformer 304 and the medium voltage rectifier may be part of the DC-DC stage 220.

The medium voltage rectifier 306 may be connected to a medium voltage link capacitor 307, which may have a link voltage of Vₘ₁. The medium voltage link capacitor 307 may absorb current fluctuations. In some embodiments, the medium voltage link capacitor 307 may be implemented as a capacitor bank. In some embodiments, the medium voltage link capacitor 307 is coupled to a medium voltage side of the converter circuitry 120. The medium voltage link capacitor 307 may be coupled to an inverter 308 which converts DC energy to AC energy. In some embodiments, the inverter 308 is part of the AC-DC stage 210. In some embodiments, the medium voltage link capacitor 307 is part of the AC-DC stage 210. Other implementations of the converter cell 301 are also possible such as a converter cell having a rectifier, a DC-DC converter, and an inverter. A bus, which may include bus terminals 133, 134, may couple the converter cell 301 to other converter cells. The bus terminals 133, 134 may constitute positive and negative terminals, respectively.

The converter cell 311 may be implemented in a similar or analogous manner as the converter cell 301. The converter cell 311 may include a low voltage bus capacitor 312, which may be at a voltage of V_{L2}. The low voltage bus capacitor 312 may be connected to a low voltage inverter 313 which converts low voltage DC energy to high-frequency AC energy. The low voltage inverter 313 may be connected to a transformer 314, such as a high frequency isolation transformer to step up AC voltage. The transformer may include a magnetic core and transformer windings. In some embodiments, one or more noise mitigating devices such as a passive choke may be connected to the transformer 304. The transformer 314 may be connected to a medium voltage rectifier 316, which converts high frequency AC energy to DC energy. In some embodiments, the low voltage side of the converter circuitry 120 (e.g., the low voltage side of the converter cell 311), the transformer 314 and the medium voltage rectifier 316 may be part of the DC-DC stage 220.

The medium voltage rectifier 316 may be connected to a medium voltage link capacitor 317, which may have a link voltage of Vₘ₂. The medium voltage link capacitor 317 may absorb current fluctuations. In some embodiments, the medium voltage link capacitor 317 may be implemented as a capacitor bank. In some embodiments, the medium voltage link capacitor 317 is coupled to an inverter 318 which converts DC energy to AC energy. In some embodiments, the inverter 318 is part of the AC-DC stage 210. In some embodiments, the medium voltage link capacitor 317 is part of the AC-DC stage 210. Other implementations of the converter cell 311 are also possible such as a converter cell having a rectifier, a DC-DC converter, and an inverter. A bus, which may include bus terminals 133, 135, may couple the converter cell 311 to other converter cells. The bus terminals 133, 135 may constitute positive and negative terminals, respectively. For example, the bus terminal 133 may connect the converter cell 301 to the converter cell 311.

The DC-DC stage noise mitigation system 222 may be configured to obtain or derive one or more attributes from one or more sensor signals. For example, the one or more attributes may include a common mode noise attribute indicative of an amount of common mode noise from one or more sensor signals. The sensor signals may additionally or alternatively include one or more signals indicative of a power transmission efficiency or power loss, and one or more signals indicative of a power quality (e.g., a relative amount of harmonic current), such as Current Total Demand Distortion (iTDD) which divides a total harmonic current by a peak demand of load current. The sensor signals may include signals from one or more DC-DC stage converter sensors 150 or from one or more AC-DC stage converter sensors 130. In some embodiments, the one or more DC-DC stage converter sensors 150 or from one or more AC-DC stage converter sensors 130 may be electrically coupled to wires or one or more other components of the converter circuitry 120. The sensor signals may include or be indicative of any one or more operational conditions within the DC-DC stage 220 or the AC-DC stage 210, such as electrical attributes, loading conditions, or environmental conditions such as temperature or humidity. Electrical attributes may include, without limitation, voltage, current, capacitance, or inductance such as V_{L1}, V_{L2}, Vₘ₁, or Vₘ₂ or switching frequencies. The current, capacitance, or inductance may include intended, parasitic, or total amounts of current, capacitance, or inductance across one or more loops of the DC-DC stage 220 or the AC-DC stage 210. The electrical attributes may include or be indicative of voltage stability, frequency stability, waveform purity (e.g., extent of harmonics), presence or absence of voltage sags, swells, transients, or other anomalous conditions. The attributes may correspond to local attributes at a given loop or switching node within the DC-DC stage 220 or the AC-DC stage 210 or cumulative attributes. Cumulative attributes may be measured across different locations or loops of the DC-DC stage 220, the AC-DC stage 210, or across both the DC-DC stage 220 and the AC-DC stage 210).

The DC-DC stage noise mitigation system 222 may be configured to obtain the sensor signals from the DC-DC stage converter sensors 150 via one or more interfaces 350. Similarly, the AC-DC stage noise mitigation system 212 may be configured to obtain the sensor signals from the AC-DC stage converter sensors 130 via one or more interfaces 330. Although not shown for simplicity, the DC-DC stage noise mitigation system 222 may be configured to obtain the sensor signals from the AC-DC stage converter sensors 130 via one or more interfaces (e.g., the interfaces 350 or different interfaces). The AC-DC stage noise mitigation system 212 may be configured to obtain the sensor signals from the DC-DC stage converter sensors 150 via one or more interfaces (e.g., the interfaces 330 or different interfaces).

Any interfaces implemented across any figures (e.g., the interfaces 330, 350, or other interfaces) may communicate sensor signals from the AC-DC stage converter sensors 130 or the DC-DC stage converter sensors 150. The sensor signals may be indicative of or used to derive state information such as operational statuses or status updates. In some embodiments, any interfaces may be configured via control signals or user interfaces as needed. Any interfaces may be configured to convert commands from the DC-DC stage noise mitigation system 222 or the AC-DC stage noise mitigation system 212 into signals. For example, the DC-DC stage noise mitigation system 222 may transmit commands requesting certain sensor data. The interfaces 350 may translate these commands into specific actions to convert signals from the DC-DC stage converter sensors 150 into sensor data. The DC-DC stage noise mitigation system 222 may be configured to regulate or tune one or more switching parameters corresponding to the low voltage inverter 303 or the medium voltage rectifier 306, or otherwise control the DC-DC stage 220, based on the one or more attributes.

In some embodiments, the DC-DC stage noise mitigation system 222 is configured to program one or more drivers 362, 372 via one or more interfaces 360, 370, respectively, which may be coupled to the medium voltage rectifier 306 and the low voltage inverter 303. For example, the DC-DC stage noise mitigation system 222 may regulate a modulation parameter or a gate driver parameter of the medium voltage rectifier 306. The DC-DC stage noise mitigation system 222 may generate and transmit one or more signals to the interface 360. The interface 360 may convert the one or more signals into an executable command to the driver 362. The driver 362 (e.g., a gate driver) may execute the executable command to cause a change in switching behavior of switches corresponding to the medium voltage rectifier 306. Similarly, the AC-DC stage noise mitigation system 212 may program one or more drivers 342 via one or more interfaces 332, which may be coupled to the medium voltage inverter 308.

The DC-DC stage noise mitigation system 222 and the AC-DC stage noise mitigation system 212 may be configured to obtain sensor signals or program one or more drivers via one or more interfaces within different converter cells in a same or similar manner. For example, the AC-DC stage noise mitigation system 212 may be configured to program one or more drivers 382 via one or more interfaces 380, which may be coupled to the medium voltage inverter 318.

Additional or fewer interfaces, and additional or fewer drivers may be implemented. In some embodiments, the interfaces (e.g., the interfaces 330, 350, 360, 370, 380) may be part of the converter control system 124. In some embodiments, the interfaces may not be part of the AC-DC stage noise mitigation system 212, the DC-DC stage noise mitigation system 222, or the common mode noise mitigation system 122. In some embodiments, the drivers (e.g., the drivers 342, 362, 372, 382) may be part of the converter circuitry 120 and therefore part of the converter control system 124. Alternative embodiments may be implemented. For example, the interfaces may be part of the AC-DC stage noise mitigation system 212, the DC-DC stage noise mitigation system 222, or the common mode noise mitigation system 122. In another example, the interfaces may not be part of the converter control system. In another example, the drivers may not be part of the converter circuitry 120. In another example, the drivers may be part of the Ac-DC stage noise mitigation system or the DC-DC stage noise mitigation system, and therefore part of the common mode noise mitigation system 122.

FIG. 4 illustrates an example medium voltage rectifier leg 406, which may be implemented as a switching leg of the medium voltage rectifier 306. In some embodiments, additionally or alternatively, the medium voltage rectifier leg (e.g., a half wave) may be implemented as a switching leg of the low voltage inverter 303. The medium voltage rectifier leg 406 is modelled to demonstrate parasitic effects. Dotted lines in FIG. 4 indicate unintentional, nonphysical connections (e.g., to ground) rather than physical wires. Instead, dotted lines indicate parasitic or unintended coupling between a circuit node and a ground, for example. For example, capacitors along a dotted line, labelled as C_{mc1}, C_{mc2}, C_{mc3}, C_{mc4}, Cₜ may represent parasitic capacitances rather than a physical capacitor. Additionally, inductors labelled as lₚ₁, lₚ₂, and lₚ₃ may indicate parasitic inductances rather than physical inductors. Dotted line connections to ground may represent parasitic coupling to a ground rather than an actual physical connection to a ground.

In some embodiments, current may flow from a rail connection 410 (e.g., a positive rail connection) through a path with an inductor 412, through a load 416 and to a switching node 420. The rail connection 410 may couple with a previous stage or a previous converter device (e.g., rectifier or inverter). In some embodiments, the inductor 412 represents a physical inductor. In some embodiments, the load 416 may be connected to adjustable resistance. For example, loading conditions as previously referred to may be construed as different resistances on the load 416. The load 416 may be coupled to a capacitor 418. The current may flow from the load 416 to a switching node 420. When a transistor 424 is ON, then the current may flow into the transistor 424, which may result in parasitic capacitance Cₜ. Current Iₖ may flow through the transistor 424 due to voltage difference Vₖ. A common mode current at the switching node 420 may be computed according to a product of Cₜ and dVₖ/dt (e.g., rate of change in Vₖ over time). Once current flows through the transistor 424, current may go through rail connection 450 (e.g., a negative rail connection). Diode 426 may be reverse biased when the transistor 424 is ON, so no current flows through the diode 426.

When the transistor 424 is in an OFF state, current may flow through the diode 426, which becomes forward biased. The diode 426 may be implemented as a freewheeling diode or a flyback diode. Current flow through the diode 426 may cause parasitic capacitance C_{d}. In some embodiments, current flows through the diode 426 back through the inductor 412 and the load 416. As evident, the switching node 420 may have a rapid rate of voltage change and therefore be a likely source of common mode noise. In some embodiments, one or more sensors (e.g., the DC-DC stage converter sensors 150) may be disposed at or coupled to the switching node 420 in order to obtain one or more signals indicative of common mode noise at the switching node 420. In some embodiments, the diode 426 may be replaced with an active switching device such as a transistor. In some embodiments, the DC-DC stage noise mitigation system 222 may be configured to regulate one or more switching parameters of the transistor 424. In some embodiments, capacitor 440, having capacitance Ce, may create a defined low-impedance path for parasitic currents to flow to a safety or reference ground or chassis, which is shown as Earth 460. A defined low-impedance path may suppress EMI, reduce radiated emissions, and ensure compliance with regulatory standards. The capacitor 440 may also protect the medium voltage rectifier leg 426 against excess leakage currents. The capacitor 440 may be implemented as a Y-class capacitor.

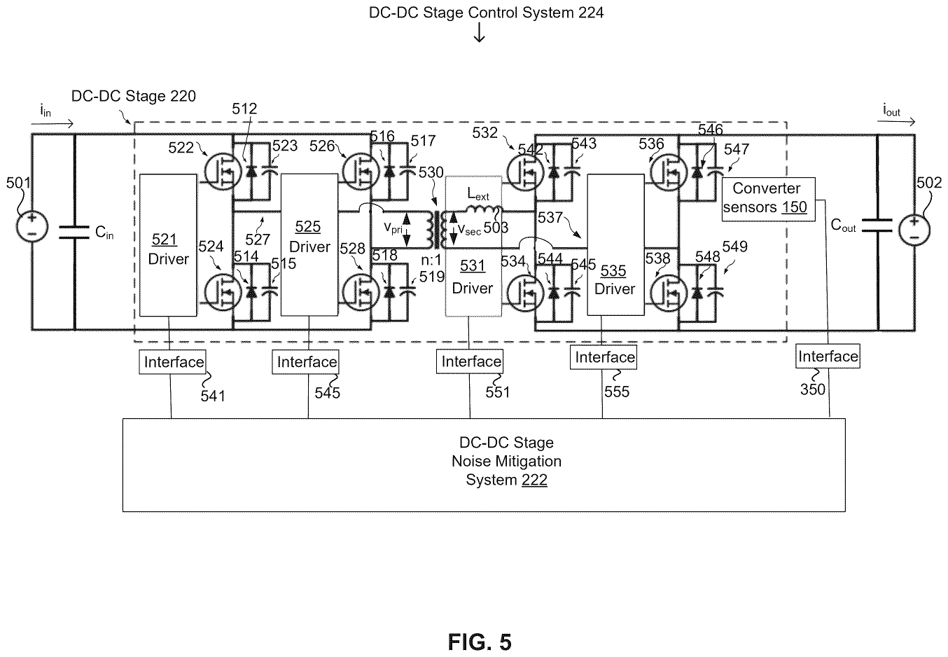

FIG. 5 is a diagram of a DC-DC stage control system 224, which may include a DC-DC stage 220 (e.g., a dual active bridge) and a DC-DC stage noise mitigation system 222. The DC-DC stage noise mitigation system 222 may be configured to regulate one or more switching parameters. The switching parameters may include modulation parameters corresponding to one or more switching pairs of the transistors or one or more gate driver parameters corresponding to one or more drivers (e.g., gate drivers). The DC-DC stage 220 may include transistors 522, 554, 556, 558, 532, 534, 536, and 538, and may include a transformer (e.g., a high frequency transformer) 530. A transformer may have a n:1 transformer ratio. Power may be exchanged from the primary bridge to the secondary bridge, or vice versa, via an external inductor 503 having inductance Lₑₓₜ. The external inductor 503 may shape transformer current based on outputted waveforms (e.g., alternating current waveforms) outputted on both primary and secondary bridges. These outputted waveforms may be implemented based on the modulation control parameters, including duty cycles and phase shifts.

In the DC-DC stage 220, complementary switch pairs comprise four pairs including transistors 522 and 524, 526 and 528, 532 and 534 and, 536 and 538. The DC-DC stage 220 may include additional circuit components such as diodes and/or capacitors to reduce reverse conduction losses and limit voltage slew rate respectively. The diodes illustrated may represent internal parasitic diodes of the transistors 522, 524, 526, 528, 532, 534, 536, and 538 and/or additional external diodes. The capacitors illustrated may represent internal capacitances of the transistors 522, 524, 526, 528, 532, 534, 536, and 538 and/or additional capacitances. Furthermore, capacitances across the capacitors are to be discharged sufficiently prior to turning on of the transistors 522, 524, 526, 528, 532, 534, 536, and 538. In particular, the converter circuit 550 may include a diode 512 and a capacitor 513 in parallel with the transistor 522, a diode 514 and a capacitor 515 in parallel with the transistor 524, a diode 516 and a capacitor 517 in parallel with the transistor 526, a diode 518 and a capacitor 519 in parallel with the transistor 528, a diode 542 and a capacitor 543 in parallel with the transistor 532, a diode 544 and a capacitor 545 in parallel with the transistor 534, a diode 546 and a capacitor 547 in parallel with the transistor 536, and a diode 548 and a capacitor 549 in parallel with the transistor 538. An energy source 501 (e.g., the energy source 102 or a different energy source) and an input capacitor having capacitance Cin may be coupled to the DC-DC stage 220 to supply power to the DC-DC stage 220. An output load 502 and an output capacitor having capacitance Cout may be coupled to the output of DC-DC stage 220.

One or more gate drivers (e.g., drivers 521, 525, 531 and 535) control switching of the transistors 522, 524, 526, 528, 532, 534, 536, and 538 ON and OFF by sending a control (e.g., voltage) signal to the gate of each transistors 522, 524, 526, 528, 532, 534, 536, and 538. The DC-DC stage noise mitigation system 222 may regulate the drivers 521, 525, 531 and 535 by programming switching parameters which may result in generation of the waveforms. In some embodiments, any of the drivers 521, 525 may be implemented as the driver 362, and any of the drivers 531, 535 may be implemented as the driver 372 in FIG. 3. The drivers 521, 525, 531, 535 may generate and transmit one or more waveforms representing control signals of the gate of the respective transistors. If a control signal to the gate has an amplitude that exceeds a threshold voltage (e.g., a gate voltage), then the transistor turns ON. Otherwise, if a driver does not transmit the waveform or if the waveform has an amplitude or voltage lower than the threshold voltage, then the transistor will remain OFF. In other examples, the drivers 521, 525, 531 and 535 may operate in a different manner.

As shown in FIG. 5, the driver 521 may control the transistors 522 and 524. The driver 525 may control the transistors 536 and 538. The driver 531 may control the transistors 532 and 534. The driver 535 may control the transistors 536 and 538. Although FIG. 5 illustrates one driver controlling two transistors, a driver may control a different number of transistors or control different transistors at different times. For example, a driver may, at one point in time, send a signal to a first transistor to switch the first transistor to an ON state while refraining from sending a signal to a second transistor to maintain the second transistor in an OFF state. In other alternative embodiments, one driver may control switching OFF and ON of a single transistor, or any number of transistors (e.g., four transistors or eight transistors).

Within the DC-DC stage 220, a first current flow path may be defined between the transistor 522, a path 527 and transistor 528. The transistors 522 and 528 may be both in an ON state or in an OFF state, as regulated by the drivers 521 and 525. A second current flow path may be defined between the transistor 526, the path 527, and the transistor 524. Thus, the transistors 526 and 524 may be both in an ON state or in an OFF state, as regulated by the drivers 525 and 521. A third current flow path may be defined between the transistor 532, a path 537, and the transistor 538. Thus, the transistors 532 and 538 may be both in an ON state or in an OFF state, as regulated by the drivers 531 and 535. A fourth current flow path may be defined between the transistor 536, the path 537, and the transistor 534. Thus, the transistors 532 and 538 may be both in an ON state or in an OFF state, as regulated by the drivers 531 and 535. Current flow from a primary bridge (e.g., the components on the left side of the transformer 530), such as current flowing through the transistors 526 and 528, may be transmitted via induction, via the external inductor 503, to a secondary bridge on the other side of the transformer 530. Meanwhile, current flow from the secondary bridge, such as current flowing through the transistors 532 and 534, may be transmitted via induction to the primary bridge. In other embodiments with different configurations, and more than two current flow paths within a single bridge, at most one current flow path is permitted to be active at a given point in time.

In FIG. 5, an entire cycle within the primary bridge may include the following operation cycles:
1. a first operation cycle, in which the transistors 522 and 528 are in an ON state while the transistors 526 and 524 are in an OFF state,
2. a first dead time in which the transistors 526, 524, 522, and 528 are all in an OFF state,
3. a second operation cycle in which the transistors 526 and 524 are in an ON state while the transistors 522 and 528 are in an OFF state,
4. a second dead time in which the transistors 526, 524, 522, and 528 are all in an OFF state,
5. followed by the first operation cycle.

Similarly, an entire cycle within the secondary bridge may include the following operation cycles:
1. a third operation cycle in which the transistors 532 and 538 are in an ON state while the transistors 536 and 534 are in an OFF state,
2. a third dead time in which the transistors 536, 534, 532, and 538 are all in an OFF state,
3. a fourth operation cycle in which the transistors 536 and 534 are in an ON state while the transistors 532 and 538 are in an OFF state,
4. a fourth dead time in which the transistors 536, 534, 532, and 538 are all in an OFF state,
5. followed by the third operation cycle.

The DC-DC stage noise mitigation system 222 may program any or all of the drivers 521, 525, 531, 535, in order to regulate one or more modulation parameters such as a phase shift or phase angle among complementary pairs of transistors, which affects an amount of common mode noise. The phase shift between complementary pairs of transistors on the primary bridge may be between a first pair including the transistors 522 and 528 and a second pair including the transistors 524 and 526. The phase shift between complementary pairs of transistors on the secondary bridge may be between a third pair including the transistors 532 and 538 and a fourth pair including the transistors 534 and 536. In some embodiments, the DC-DC stage noise mitigation system 222 programs any or all of the drivers 521, 525, 531, 535 to tune one or more gate driver parameters such as a gate driver resistance. For example, increasing a gate driver resistance may result in smoother voltage transitions and smaller amounts of common mode current.

In some embodiments, the DC-DC stage noise mitigation system 222 may program any or all of the drivers 521, 525, 531, 535 via any of the interfaces 541, 545, 551, 555. The interfaces 541, 545, 551, and/or 555 may program any of the drivers 521, 525, 531, and/or 535 consistent with one or more signals transmitted by the DC-DC stage noise mitigation system 222. The interfaces 541, 545, 551, 555 may be implemented as any of the interfaces (e.g., interfaces 360, 370) illustrated in FIG. 3. In some embodiments, outputs of the interfaces 541, 545, 551 and 555 are synchronized. Additionally, the DC-DC stage noise mitigation system 222 may obtain one or more signals from DC-DC stage converter sensors 150 via the interface 350, as also illustrated in FIG. 3.

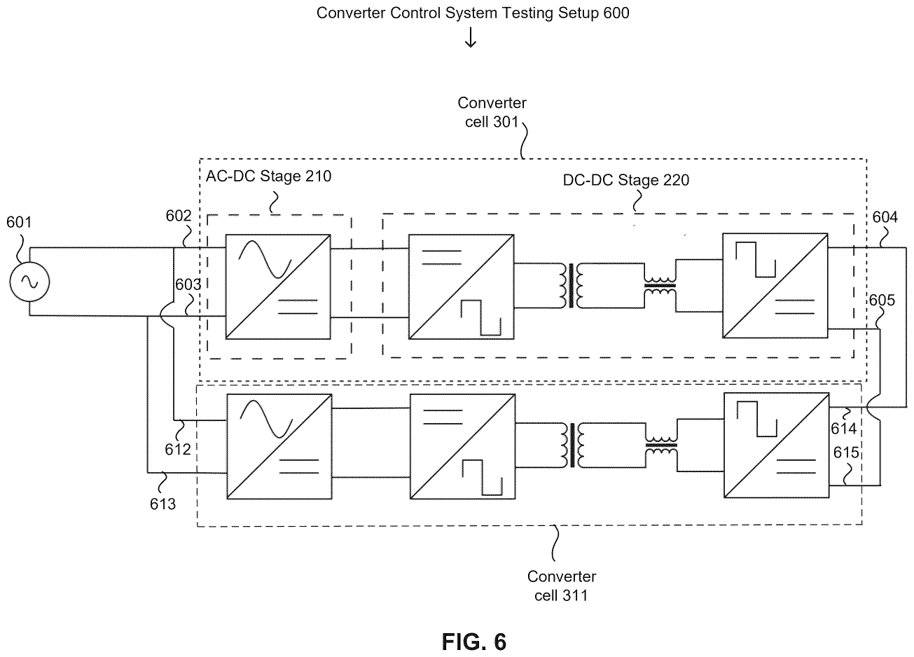

FIG. 6 is a diagram illustrating an example converter control system testing setup 600 used to mitigate common mode noise until the common mode noise reaches a satisfactory level. In some embodiments, a testing setup may include a bench testing setup. The testing setup may be used to implement a testing mode to establish one or more switching parameters to ensure that common mode noise is mitigated during actual operation of the converter control system 124. In some embodiments, a testing mode is distinct from an actual operational mode. In some embodiments, the converter circuitry 120 includes three phases and converter cells that are cascaded in series on an input side and paralleled on an output side. In some embodiments, including three phases may be construed as containing circuitry for three AC phases including three input terminals, one for each phase, to have the ability to simultaneously process three separate AC waveforms. Including three phases may result in smoother, more stable power conversion.

In FIG. 6, the converter cells 301, 311 operate back-to-back through AC-DC Stage 210 and DC-DC Stage 220. Interconnect 602 of the converter cell 301 is coupled to interconnect 612 of the converter cell 311. Interconnect 603 of the converter cell 301 is coupled to interconnect 613 of the converter cell 311. The interconnects 602 and 612, and 603 and 613, may couple corresponding AC-DC stages of corresponding converter cells 301 and 311, including the AC-DC stage 210. An energy source 601 (e.g., the energy source 102) may supply power to the converter cell 301. Meanwhile, interconnects 604, 614, and interconnects 605 and 615, may couple the respective DC-DC stages (including the DC-DC stage 220) of the converter cells 301 and 311. The setup enables validation of mitigation strategies such as modulation adjustments, and gate-drive tuning for both AC-DC stage 210 and DC-DC Stage 220 separately.

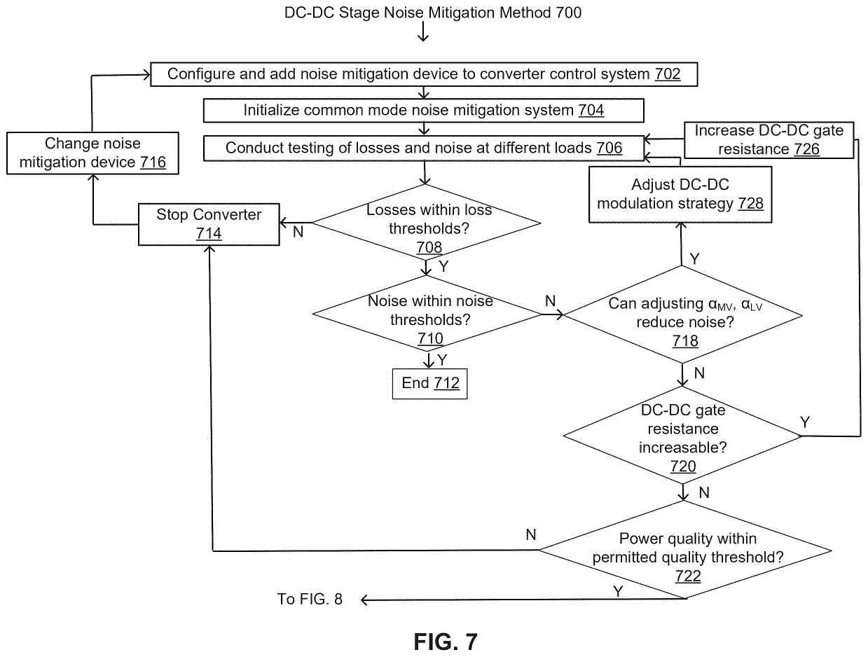

FIG. 7 is a flowchart of an example DC-DC stage noise mitigation method 700, according to some embodiments. The DC-DC stage noise mitigation method 700 may be implemented at least in part by the DC-DC stage noise mitigation system 222 to mitigate common mode noise while satisfying power loss and power-quality constraints, before escalating to AC-DC mitigation. The DC-DC stage noise mitigation system 222 may, in step 702, configure and add a noise mitigation device (e.g., a filter) to the converter circuitry 120. In some embodiments, configuring and adding a noise mitigation device may be at least partially a manual process. For example, a Y-class capacitors (e.g., Ce in FIG. 4) may provide a defined low-impedance common mode noise return to chassis/Earth (e.g., the Earth 460) while meeting safety leakage constraints. Other examples of noise mitigation devices may include common mode chokes on transformer leads or cable harnesses to impede CM current loops. Yet other example noise mitigation devices may include series resistor-capacitor (RC) snubbers across switching nodes to damp overshoot or ringing and reduce rate of voltage change over time at switching nodes such as switching node 420 in FIG. 4. Yet other example noise mitigation devices include shields or ground planes. In some embodiments, configuring a noise mitigation device includes verify device's electrical rating, placement, or interface routing to avoid unintended ground loops.

In step 704, the common mode noise mitigation system 122 may be initiated. For example, the DC-DC stage noise mitigation system 222 may be initialized. In some embodiments, the AC-DC stage noise mitigation system 212 may also be initialized. In some embodiments, initialization may include bringing the converter control system 124 to operational readiness at a safe initial condition. For example, initialization may include validating sensor calibrations of one or more sensors (e.g., DC-DC stage converter sensors 150, AC-DC stage converter sensors 130) including current probes, voltage transducers for V_{L1}/V_{L2}, Vₘ₁/Vₘ₂, or of temperature sensors. In some embodiments, initialization includes confirming driver readiness and initial gate resistances for transistors (e.g., transistors 522/524/526/528 and 532/534/536/538 in FIG. 5. In some embodiments, initialization includes configuring control references for αMV, αLV and dead times or ensuring capacitive discharge interlocks or other conditions (e.g., zero voltage switching, zero current switching) are satisfied. In some embodiments, initializing may encompass starting at no load conditions (e.g., that the load 416 is disconnected or connected to a high resistance) to simulate an open circuit so a negligible amount of current flows through the load 416.

In step 706, the common mode noise mitigation system 122 may conduct testing of power losses and common mode noise at different loads. Step 706 may encompass a sweep of loading conditions such as no-load, light, nominal, and heavy loading conditions. A sweep of loading conditions may include adjusting resistive loads (e.g., via software or hardware) or dynamometer-equivalent fixtures on the load 416. At each loading condition, the DC-DC stage noise mitigation system 222 may determine common mode noise attributes at locations such as DC-DC switching nodes (e.g., the switching node 420) such as common mode noise current waveforms or spectra. In some embodiments, the DC-DC stage noise mitigation system 222 may determine or record power losses at each loading condition which may include device conduction or switching losses, transformer losses, inductor (e.g., inductor 503) losses, or thermal margins. In some embodiments, the DC-DC stage noise mitigation system 222 may determine or record power quality (e.g., at a DC output, Cout as illustrated in FIG. 5), including ripples or harmonic content measurements. In some embodiments, the DC-DC stage noise mitigation system 222 may implement synchronized sampling across interfaces (e.g., interfaces 541, 545, 551, 555) to correlate driver commands to observed common mode noise.

In decision 708, the DC-DC stage noise mitigation system 222 determines whether power losses fall within one or more loss thresholds. In some embodiments, if the losses are not within loss thresholds (e.g., permitted power losses), the DC-DC stage noise mitigation system 222 may halt or reverse any adjustments that otherwise contribute to power loss (e.g., excessive dead time or gate resistance increases). In some embodiments, the DC-DC stage noise mitigation system 222 may try to bring the losses back to within the loss thresholds.

In decision 710, if the losses satisfy or can be brought back to satisfy the one or more loss thresholds, the DC-DC stage noise mitigation system 222 may determine whether common mode noise is within a noise threshold. For example, the DC-DC stage noise mitigation system 222 may compare a measured common mode current and certain rates of change of voltage at one or more switching nodes against one or more common mode noise thresholds. If the DC-DC stage noise mitigation system 222 determines that the common mode noise attributes are within common mode noise thresholds across different loading conditions, then the DC-DC stage noise mitigation system 222 terminates in step 712. In step 712, no further common mode noise mitigation is needed.

If the losses cannot be brought to within the loss thresholds, then the DC-DC stage noise mitigation system 222 may stop the converter (e.g., deactivate the converter circuitry 120) in step 714. Once the converter is stopped, in step 716, a noise mitigation device may be changed, or additional noise mitigation devices may be added. For example, filter parameters or locations at which the noise mitigation devices are placed may be adjusted. After each change of the noise mitigation device, the method 700 may proceed to step 706.

Otherwise, if the DC-DC stage noise mitigation system 222 determines in decision 710 that the common mode noise attributes are outside of one or more common mode noise thresholds then in decision 718, the DC-DC stage noise mitigation system 222 tries to adjust a modulation strategy which may include one or more modulation parameters such as phase angle corresponding to a low voltage or medium voltage side of the converter circuitry 120 (e.g., α_{MV}, α_{LV}). For example, changing a modulation strategy may include increasing relevant phase shifts, adjusting duty ratios, or refining dead times may result in softer transitions and permit time to discharge some parasitic capacitances before turning ON switches. In some embodiments, changing a modulation strategy includes reducing DC-DC switching frequency to reduce edge rates.

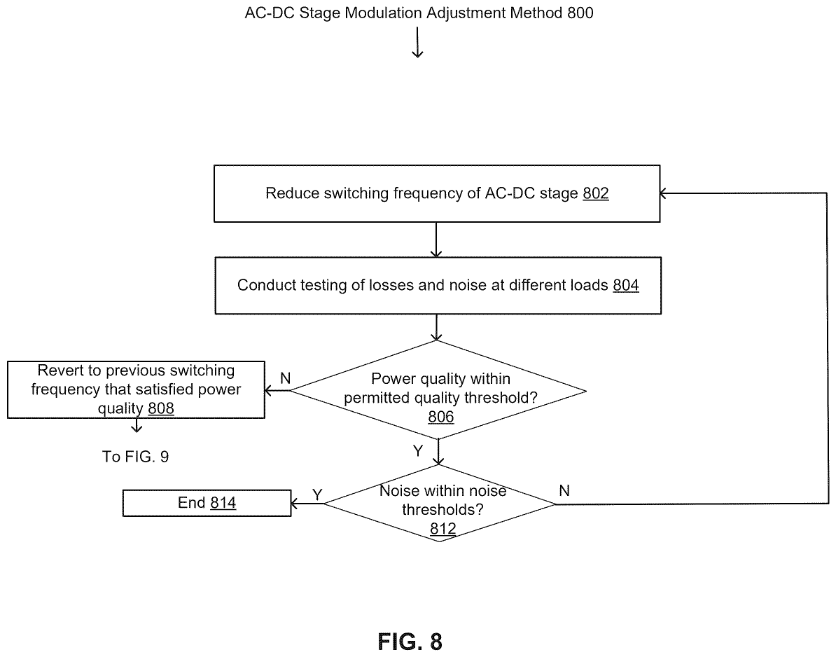

If the DC-DC stage noise mitigation system 222 determines in decision 718 that adjusting the modulation parameters fails to decreases the common mode noise levels, then in decision 720 the DC-DC stage noise mitigation system 222 determines whether the DC-DC gate driver resistance is increasable within driver hardware or converter circuitry 120 limitations. If the DC-DC gate driver resistance is not increasable, then the DC-DC stage noise mitigation system 222 determines, in decision 722, whether a power quality is within a permitted power quality threshold. Power quality may include measure of amount of harmonics, such as iTDD. If the power quality has degraded beyond permitted thresholds, then the method 700 may proceed to stop converter operations in step 714. If the power quality is acceptable, then the method 700 may proceed to step 802 in FIG. 8, to adjust an AC-DC modulation strategy.

If the DC-DC gate driver resistance is increasable, the DC-DC stage noise mitigation system 222 may increase the DC-DC gate driver resistance in step 726 (e.g., in controlled increments) and proceed to step 706. In some embodiments, the DC-DC stage noise mitigation system 222 may ensure that the increase of gate driver resistance does not compromise cross conducting (e.g., timing among different switches), or disturb any soft-switching windows before increasing gate driver resistance.

If the DC-DC stage noise mitigation system 222 determines in decision 718 that adjusting the modulation parameters decreases the common mode noise levels, then in step 728 the DC-DC stage noise mitigation system 222 adjusts the DC-DC modulation strategy. From step 728, the method 700 returns to step 706.

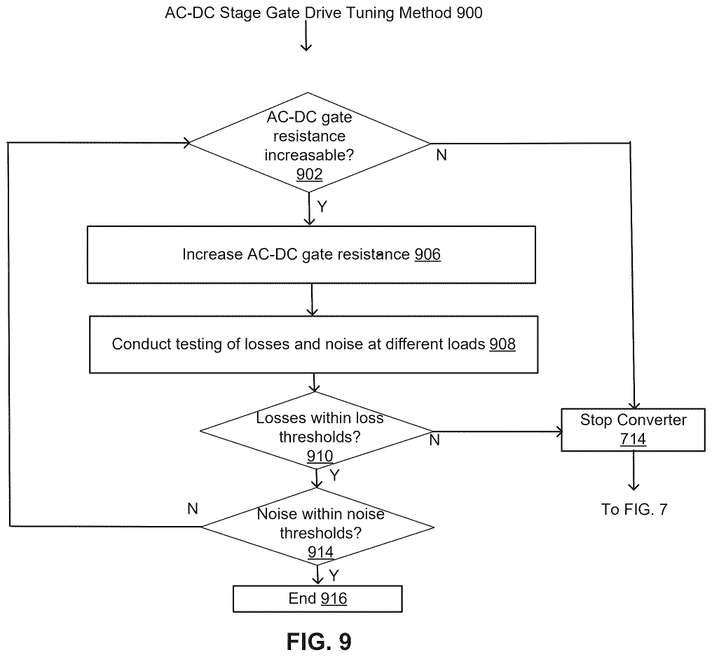

FIG. 8 illustrates an example AC-DC stage modulation adjustment method 800. In some embodiments, if the method 700 in FIG. 7 proceeded to step 724, then the AC-DC stage modulation adjustment method 800 may be implemented, for example, by the AC-DC stage noise mitigation system 212. In step 802, the AC-DC stage noise mitigation system 212 may reduce switching frequency of the AC-DC stage (e.g., AC-DC stage 210) to manage high-frequency harmonics and mitigate EMI (while considering power-quality and loss trade-offs). In step 804, the AC-DC stage noise mitigation system 212 may conduct testing of losses and noise across the different loading conditions. In step 806, the AC-DC stage noise mitigation system 212 may check that power quality is within permitted thresholds (e.g., harmonic distortion criteria such as iTDD per IEEE 519). If not within thresholds, then in step 808, the AC-DC stage noise mitigation system 212 may revert to the previous switching frequency that was confirmed to have satisfied power quality constraints. From step 808, the method 800 may proceed to decision 902 in FIG. 9 to test AC-DC gate driver resistance to assess whether increasing AC-DC gate driver resistance is feasible. In decision 812, the AC-DC stage noise mitigation system 212 may determine whether a common mode noise is within common mode noise thresholds, in response to a positive determination in decision 806. If the AC-DC stage noise mitigation system 212 determines the common mode noise is within common mode noise thresholds, then the method proceeds to step 814, in which the method 800 is terminated due to satisfaction. If the AC-DC stage noise mitigation system 212 determines the common mode noise is within common mode noise thresholds, then the method returns to step 802.

FIG. 9 illustrates an example AC-DC stage gate drive tuning method 900. In some embodiments, if the method 800 in FIG. 8 proceeded to step 810, then the AC-DC stage gate drive tuning method 900 may be implemented, for example, by the AC-DC stage noise mitigation system 212. In decision 902, the AC-DC stage noise mitigation system 212 may determine whether the AC-DC gate resistance is increasable. If not, then the AC-DC stage noise mitigation system 212 may stop the converter in step 714. If yes, then the AC-DC stage noise mitigation system 212 may increase the AC-DC gate driver resistance in step 906. In some embodiments, the increase in AC-DC gate driver resistance may be performed in increments to slow edge rates, ensure sufficient dead time margins, that switching losses are not excessive and thermal constraints are satisfied. In step 908, the AC-DC gate driver resistance in step 906 may conduct testing of losses and common mode noise at different loading conditions analogous to step 706 in FIG. 7. In decision 910, the AC-DC stage noise mitigation system 212 may determine whether power losses are within one or more power loss thresholds. If not, then the AC-DC stage noise mitigation system 212 may proceed to step 714 to stop the converter. If so, the AC-DC stage noise mitigation system 212 may determine whether common mode noise is within one or more common mode noise thresholds in decision 914. If so, then the AC-DC stage noise mitigation system 212 may terminate the method 900 in step 916 (due to satisfaction). If not, then the method 900 may return to decision 902. Upon proceeding to step 714, the method may proceed to step 716 in FIG. 7.

Controllers (e.g., AC-DC stage noise mitigation system 212, DC-DC stage noise mitigation system 222) may communicate with one another, or with interfaces, via a network. The network may include any secured communication network such as an encrypted network. The network may represent one or more computer networks (e.g., LAN, WAN, or the like) or other transmission mediums. In some embodiments, the network includes one or more computing devices, routers, cables, buses, and/or other network topologies (e.g., mesh, and the like). In some embodiments, the network may be wired and/or wireless. In various embodiments, the network may include the Internet, one or more wide area networks (WANs) or local area networks (LANs), one or more networks that may be public, private, IP-based, non-IP based, and so forth.

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

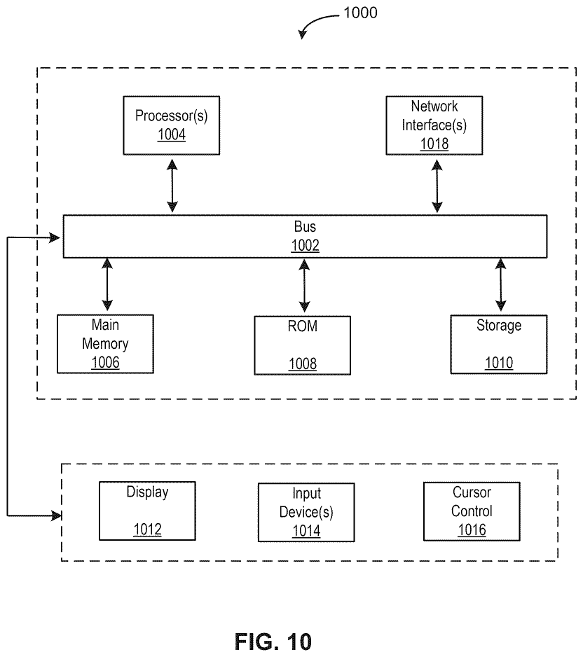

FIG. 10 is a block diagram of a computer system 1000 upon which any of the embodiments described herein may be implemented. The computer system 1000 includes a bus 1002 or other communication mechanism for communicating information, one or more hardware or other processors, such as cloud processors, 1004 coupled with bus 1002 for processing information. A description that a device performs a task is intended to mean that one or more of the processor(s) 1004 performs.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to display 1012, such as a cathode ray tube (CRT) or LCD display (or touch screen), for displaying information to a computer user. Input device(s) 1014, including alphanumeric and other keys, are coupled to bus 1002 for communicating information and command selections to processor 1004. Another type of user input device is cursor control 1016. The computer system 1000 also includes a communication interface 1018 coupled to bus 1002.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Any reference to “approximate,” “near,” “threshold,” “sufficiency,” “uniform,” may be construed to encompass any applicable value or degree, such as any applicable value or degree sufficient to satisfy a given outcome, such as a common mode noise level low enough so that typical converter operation is not compromised. As another example, a satisfactory power quality standard may refer to satisfaction of one or more regulatory standards such as IEEE 519. In some examples, a threshold level, similarity or degree thereof may be construed to include any values such as 99.9 percent, 99.75 percent, 99.5 percent, 99 percent, 98 percent, 95 percent, 90 percent, 80 percent, 75 percent, or any other value therebetween, or any ranges therebetween. Additionally or alternatively, a threshold similarity, degree, or level may be construed as qualitatively satisfying some condition. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to disclose the scenario of A “or” B. Reference to A “or” B may be construed to disclose the scenario of A “and” B.

The present technologies are described above with reference to example embodiments. It will be apparent to those skilled in the art that various modifications may be made and other embodiments may be used without departing from the broader scope of the present technologies. Therefore, these and other variations upon the example embodiments are intended to be covered by the present technologies.

1. A converter control system for mitigating common mode noise within a converter, the converter control system comprising:
converter circuitry including an alternating current (AC)-direct current (DC) power conversion stage and a DC-DC power conversion stage; and
a common mode noise mitigation system comprising:
one or more interfaces configured to communicate with the converter circuitry; and controller circuitry configured to perform:
at different converter loading conditions:
obtaining a power loss attribute indicative of power loss in at least a portion of the controller circuitry; and
in response to the power loss attribute satisfying a power loss threshold, obtaining a common mode noise attribute indicative of an amount of common mode noise within one or more locations corresponding to the converter circuitry;
selectively regulating one or more DC-DC stage switching parameters corresponding to one or more DC-DC stage switches of the DC-DC power conversion stage based on the common mode noise attribute at the different loading conditions;
in response to regulating the one or more DC-DC stage switching parameters:
at the different loading conditions:
obtaining one or more updated common mode noise attributes indicative of one or more updated amounts of the common mode noise at the different loading conditions; and
obtaining a power quality attribute indicative of a power quality of power outputted through the controller circuitry; and
in response to the power quality attribute satisfying a power quality threshold, selectively regulating one or more AC-DC stage switching parameters corresponding to one or more AC-DC stage switches of the AC-DC power conversion
stage based on an updated common mode noise attribute.

2. The converter control system of claim 1, wherein the DC-DC stage switching parameters comprise a DC-DC modulation parameter or a DC-DC gate driver parameter; and selectively regulating the one or more DC-DC stage switching parameters comprises:
selectively regulating the DC-DC modulation parameter based on the common mode noise attribute;
in response to regulating the DC-DC modulation parameter, obtaining a first updated common mode noise attribute indicative of a first updated amount of the common mode noise;
selectively tuning the DC-DC gate driver parameter corresponding to one or more DC-DC gate drivers of the DC-DC power conversion stage based on the first updated amount of the common mode noise;
in response to tuning the DC-DC gate driver parameter, obtaining a second updated common mode noise attribute indicative of a second updated amount of the common mode noise; and selectively regulating the one or more AC-DC stage switching parameters comprises:
selectively regulating an AC-DC modulation parameter corresponding to one or more AC-DC stage switches of the AC-DC power conversion stage based on the second updated common mode noise attribute;
in response to regulating the AC-DC modulation parameter, obtaining a third updated common mode noise attribute indicative of a third updated amount of the common mode noise; and
selectively tuning an AC-DC gate driver parameter corresponding to one or more AC-DC gate drivers of the AC-DC power conversion stage based on the third updated amount of the common mode noise, and wherein:
the one or more locations correspond to one or more switching nodes of the converter circuitry, the one or more DC-DC stage switches correspond to one or more half bridges or dual active bridges (DABs);
the common mode noise attribute, the second updated common mode noise attribute, and the third updated common mode noise attribute correspond to different loading conditions.

3. The converter control system of claim 2, wherein the DC-DC modulation parameter comprises a DC-DC stage phase shift corresponding to the one or more DC-DC stage switches, and selectively regulating the DC-DC modulation parameter comprises:
in response to the amount of the common mode noise being above a threshold common mode noise level, increasing the DC-DC stage phase shift corresponding to the one or more DC-DC stage switches if an increase in the DC-DC stage phase shift lowers the amount of the common mode noise.

4. The converter control system of claim 2, wherein the DC-DC gate driver parameter comprises a DC-DC gate driver resistance; and selectively tuning the DC-DC gate driver parameter comprises:
in response to the first updated amount of the common mode noise being above a threshold common mode noise level, increasing the DC-DC gate driver resistance if the DC-DC gate driver resistance is increasable and if an increase in the DC-DC gate driver resistance lowers the amount of the common mode noise.

5. The converter control system of claim 2, wherein the AC-DC modulation parameter comprises an AC-DC stage phase shift corresponding to the one or more AC-DC stage switches, and selectively regulating the AC-DC modulation parameter comprises:
in response to the second updated amount of the common mode noise being above a threshold common mode noise level, increasing the AC-DC stage phase shift corresponding to the one or more AC-DC stage switches if an increase in the AC-DC stage phase shift lowers the amount of the common mode noise.

6. The converter control system of claim 2, wherein the AC-DC gate driver parameter comprises an AC-DC gate driver resistance; and selectively tuning the AC-DC gate driver parameter comprises:
in response to the third updated amount of the common mode noise being above a threshold common mode noise level, increasing the AC-DC gate driver resistance if the AC-DC gate driver resistance is increasable.

7. The converter control system of claim 2, wherein the DC-DC modulation parameter comprises a DC-DC stage phase shift corresponding to the one or more DC-DC stage switches, and selectively regulating the DC-DC modulation parameter comprises:
in response to the amount of the common mode noise being above a threshold common mode noise level, iteratively increasing the DC-DC stage phase shift corresponding to the one or more DC-DC stage switches if an increase in the DC-DC stage phase shift lowers the amount of the common mode noise; and
at each DC-DC stage phase shift increase iteration, obtaining a first iteratively updated common mode noise attribute indicative of a first iteratively updated amount of the common mode noise, wherein the iteratively increasing the DC-DC stage phase shift comprises iteratively increasing the DC-DC stage phase shift until the first iteratively updated amount of the common mode noise falls within the threshold common mode noise level, wherein the first iteratively updated common mode noise attribute corresponds to the first updated common mode noise attribute; and selectively tuning the DC-DC gate driver parameter comprises:
in response to the DC-DC stage phase shift reaching a DC-DC stage phase shift threshold, and the first iteratively updated amount of the common mode noise still being above the threshold common mode noise level, tuning the DC-DC gate driver parameter, wherein at the DC-DC stage phase shift threshold, any permissible change in the DC-DC stage phase shift fails to lower the amount of the common mode noise.

8. The converter control system of claim 7, wherein the DC-DC gate driver parameter comprises a DC-DC gate driver resistance; and selectively tuning the DC-DC gate driver parameter comprises:
in response to the first updated amount of the common mode noise being above a threshold common mode noise level, iteratively increasing the DC-DC gate driver resistance if the DC-DC gate driver resistance is increasable and if an increase in the DC-DC gate driver resistance lowers the amount of the common mode noise; and
at each DC-DC gate driver resistance increase iteration, obtaining a second iteratively updated common mode noise attribute indicative of a second iteratively updated amount of the common mode noise, wherein the iteratively increasing the DC-DC gate driver resistance comprises iteratively increasing the DC-DC gate driver resistance until the second iteratively updated amount of the common mode noise falls within the threshold common mode noise level, wherein the second iteratively updated common mode noise attribute corresponds to the second updated common mode noise attribute; and selectively tuning the AC-DC gate driver parameter comprises:
in response to the DC-DC gate driver resistance reaching a DC-DC gate driver resistance threshold, and the second iteratively updated amount of the common mode noise still being above the threshold common mode noise level, regulating the AC-DC modulation parameter, wherein at the DC-DC gate driver resistance threshold, any permissible change in the DC-DC gate driver resistance fails to lower the amount of the common mode noise.

9. The system of claim 8, wherein selectively regulating the AC-DC modulation parameter comprises:
iteratively increasing the AC-DC stage phase shift corresponding to the one or more AC-DC stage switches if an increase in the AC-DC stage phase shift lowers the amount of the common mode noise; and
at each AC-DC stage phase shift increase iteration, obtaining a third iteratively updated common mode noise attribute indicative of a third iteratively updated amount of the common mode noise, wherein the iteratively increasing the AC-DC stage phase shift comprises iteratively increasing the AC-DC stage phase shift until the third iteratively updated amount of the common mode noise falls within the threshold common mode noise level, wherein the third iteratively updated common mode noise attribute corresponds to the third updated common mode noise attribute; and selectively tuning the AC-DC gate driver parameter comprises:
in response to the AC-DC stage phase shift reaching a AC-DC stage phase shift threshold, and the third iteratively updated amount of the common mode noise still being above the threshold common mode noise level, tuning the AC-DC gate driver parameter, wherein at the AC-DC stage phase shift threshold, any permissible change in the AC-DC stage phase shift fails to lower the amount of the common mode noise.

10. The system of claim 2, wherein the controller circuitry is further configured to perform:
in response to determining that the DC-DC gate driver resistance has reached a DC-DC gate driver resistance threshold, and the second iteratively updated amount of the common mode noise still being above the threshold common mode noise level, determining whether a power quality is within a power quality threshold, wherein at the DC-DC gate driver resistance threshold, any permissible change in the DC-DC gate driver resistance fails to lower the amount of the common mode noise; and selectively regulating the AC-DC modulation parameter is in response to determining that the power quality is within a power quality threshold.

11. A method for mitigating common mode noise within a converter implemented by controller circuitry within a common mode noise mitigation system of a converter control system, the electric system comprising converter circuitry including an alternating current (AC)-direct current (DC) power conversion stage and a DC-DC power conversion stage, the converter control system comprising the controller circuitry and one or more interfaces communicating with the converter circuitry, the method comprising:
at different converter loading conditions:
obtaining a power loss attribute indicative of power loss in at least a portion of the controller circuitry; and
in response to the power loss attribute satisfying a power loss threshold, obtaining a common mode noise attribute indicative of an amount of common mode noise within one or more locations corresponding to the converter circuitry;
selectively regulating one or more DC-DC stage switching parameters corresponding to one or more DC-DC stage switches of the DC-DC power conversion stage based on the common mode noise attribute at the different loading conditions;
in response to regulating the one or more DC-DC stage switching parameters:
at the different loading conditions:
obtaining one or more updated common mode noise attributes indicative of one or more updated amounts of the common mode noise at the different loading conditions; and
obtaining a power quality attribute indicative of a power quality of power outputted through the controller circuitry; and
in response to the power quality attribute satisfying a power quality threshold, selectively regulating one or more AC-DC stage switching parameters corresponding to one or more AC-DC stage switches of the AC-DC power conversion stage based on an updated common mode noise attribute.

12. The method of claim 11, wherein the DC-DC stage switching parameters comprise a DC-DC modulation parameter or a DC-DC gate driver parameter; and selectively regulating the one or more DC-DC stage switching parameters comprises:
selectively regulating the DC-DC modulation parameter based on the common mode noise attribute;
in response to regulating the DC-DC modulation parameter, obtaining a first updated common mode noise attribute indicative of a first updated amount of the common mode noise;
selectively tuning the DC-DC gate driver parameter corresponding to one or more DC-DC gate drivers of the DC-DC power conversion stage based on the first updated amount of the common mode noise;
in response to tuning the DC-DC gate driver parameter, obtaining a second updated common mode noise attribute indicative of a second updated amount of the common mode noise; and selectively regulating the one or more AC-DC stage switching parameters comprises:
selectively regulating an AC-DC modulation parameter corresponding to one or more AC-DC stage switches of the AC-DC power conversion stage based on the second updated common mode noise attribute;
in response to regulating the AC-DC modulation parameter, obtaining a third updated common mode noise attribute indicative of a third updated amount of the common mode noise; and
selectively tuning an AC-DC gate driver parameter corresponding to one or more AC-DC gate drivers of the AC-DC power conversion stage based on the third updated amount of the common mode noise, and wherein:
the one or more locations correspond to one or more switching nodes of the converter circuitry, the one or more DC-DC stage switches correspond to one or more half bridges or dual active bridges (DABs);
the common mode noise attribute, the second updated common mode noise attribute, and the third updated common mode noise attribute correspond to different loading conditions.

13. The method of claim 12, wherein the DC-DC modulation parameter comprises a DC-DC stage phase shift corresponding to the one or more DC-DC stage switches, and selectively regulating the DC-DC modulation parameter comprises:
in response to the amount of the common mode noise being above a threshold common mode noise level, increasing the DC-DC stage phase shift corresponding to the one or more DC-DC stage switches if an increase in the DC-DC stage phase shift lowers the amount of the common mode noise.

14. The method of claim 12, wherein the DC-DC gate driver parameter comprises a DC-DC gate driver resistance; and selectively tuning the DC-DC gate driver parameter comprises:
in response to the first updated amount of the common mode noise being above a threshold common mode noise level, increasing the DC-DC gate driver resistance if the DC-DC gate driver resistance is increasable and if an increase in the DC-DC gate driver resistance lowers the amount of the common mode noise.

15. The method of claim 12, wherein the AC-DC modulation parameter comprises an AC-DC stage phase shift corresponding to the one or more AC-DC stage switches, and selectively regulating the AC-DC modulation parameter comprises:
in response to the second updated amount of the common mode noise being above a threshold common mode noise level, increasing the AC-DC stage phase shift corresponding to the one or more AC-DC stage switches if an increase in the AC-DC stage phase shift lowers the amount of the common mode noise.

16. The method of claim 12, wherein the AC-DC gate driver parameter comprises an AC-DC gate driver resistance; and selectively tuning the AC-DC gate driver parameter comprises:
in response to the third updated amount of the common mode noise being above a threshold common mode noise level, increasing the AC-DC gate driver resistance if the AC-DC gate driver resistance is increasable.

17. The method of claim 12, wherein the DC-DC modulation parameter comprises a DC-DC stage phase shift corresponding to the one or more DC-DC stage switches, and selectively regulating the DC-DC modulation parameter comprises:
in response to the amount of the common mode noise being above a threshold common mode noise level, iteratively increasing the DC-DC stage phase shift corresponding to the one or more DC-DC stage switches if an increase in the DC-DC stage phase shift lowers the amount of the common mode noise; and
at each DC-DC stage phase shift increase iteration, obtaining a first iteratively updated common mode noise attribute indicative of a first iteratively updated amount of the common mode noise, wherein the iteratively increasing the DC-DC stage phase shift comprises iteratively increasing the DC-DC stage phase shift until the first iteratively updated amount of the common mode noise falls within the threshold common mode noise level, wherein the first iteratively updated common mode noise attribute corresponds to the first updated common mode noise attribute; and selectively tuning the DC-DC gate driver parameter comprises:
in response to the DC-DC stage phase shift reaching a DC-DC stage phase shift threshold, and the first iteratively updated amount of the common mode noise still being above the threshold common mode noise level, tuning the DC-DC gate driver parameter, wherein at the DC-DC stage phase shift threshold, any permissible change in the DC-DC stage phase shift fails to lower the amount of the common mode noise.

18. The method of claim 17, wherein the DC-DC gate driver parameter comprises a DC-DC gate driver resistance; and selectively tuning the DC-DC gate driver parameter comprises:
in response to the first updated amount of the common mode noise being above a threshold common mode noise level, iteratively increasing the DC-DC gate driver resistance if the DC-DC gate driver resistance is increasable and if an increase in the DC-DC gate driver resistance lowers the amount of the common mode noise; and
at each DC-DC gate driver resistance increase iteration, obtaining a second iteratively updated common mode noise attribute indicative of a second iteratively updated amount of the common mode noise, wherein the iteratively increasing the DC-DC gate driver resistance comprises iteratively increasing the DC-DC gate driver resistance until the second iteratively updated amount of the common mode noise falls within the threshold common mode noise level, wherein the second iteratively updated common mode noise attribute corresponds to the second updated common mode noise attribute; and selectively tuning the AC-DC gate driver parameter comprises:
in response to the DC-DC gate driver resistance reaching a DC-DC gate driver resistance threshold, and the second iteratively updated amount of the common mode noise still being above the threshold common mode noise level, regulating the AC-DC modulation parameter, wherein at the DC-DC gate driver resistance threshold, any permissible change in the DC-DC gate driver resistance fails to lower the amount of the common mode noise.

19. The method of claim 18, wherein selectively regulating the AC-DC modulation parameter comprises:
iteratively increasing the AC-DC stage phase shift corresponding to the one or more AC-DC stage switches if an increase in the AC-DC stage phase shift lowers the amount of the common mode noise; and
at each AC-DC stage phase shift increase iteration, obtaining a third iteratively updated common mode noise attribute indicative of a third iteratively updated amount of the common mode noise, wherein the iteratively increasing the AC-DC stage phase shift comprises iteratively increasing the AC-DC stage phase shift until the third iteratively updated amount of the common mode noise falls within the threshold common mode noise level, wherein the third iteratively updated common mode noise attribute corresponds to the third updated common mode noise attribute; and selectively tuning the AC-DC gate driver parameter comprises:
in response to the AC-DC stage phase shift reaching a AC-DC stage phase shift threshold, and the third iteratively updated amount of the common mode noise still being above the threshold common mode noise level, tuning the AC-DC gate driver parameter, wherein at the AC-DC stage phase shift threshold, any permissible change in the AC-DC stage phase shift fails to lower the amount of the common mode noise.

20. The method of claim 12, further comprising:
in response to determining that the DC-DC gate driver resistance has reached a DC-DC gate driver resistance threshold, and the second iteratively updated amount of the common mode noise still being above the threshold common mode noise level, determining whether a power quality is within a power quality threshold, wherein at the DC-DC gate driver resistance threshold, any permissible change in the DC-DC gate driver resistance fails to lower the amount of the common mode noise; and selectively regulating the AC-DC modulation parameter is in response to determining that the power quality is within a power quality threshold, wherein the AC-DC modulation parameter comprises an AC-DC stage phase shift corresponding to the one or more AC-DC stage switches, the phase shift corresponds to a DC-DC stage phase shift, each phase shift increase iteration corresponds to a DC-DC stage phase shift increase iteration, the phase shift threshold corresponds to a DC-DC stage phase shift threshold.
